(19) United States
(12) Patent Application Publication
(10) Pub. No.: US 2022/0207968 A1
(43) Pub. Date: Jun. 30, 2022

(54) System for an Alternative Version of Gaming

(71) Applicant: Platform Gaming Technologies, Inc., Indianapolis, IN (US)

(72) Inventor: David Brian Hirsch, Indianapolis, IN (US)

(73) Assignee: Platform Gaming Technologies, Inc., Indianapolis, IN (US)

(21) Appl. No.: 17/699,964

(22) Filed: Mar. 21, 2022

Related U.S. Application Data
(63) Continuation-in-part of application No. 16/939,929, filed on Jul. 27, 2020, now Pat. No. 11,308,768.
(60) Provisional application No. 62/886,453, filed on Aug. 14, 2019.

(51) Int. Cl. G07F 17/32

(52) U.S. Cl. CPC G07F 17/3293; G07F 17/3211; G07F 17/3267; G07F 17/3227

(57) ABSTRACT

A game having a one-step progression (player makes a bet and then receives a first set of cards) or a two-step progression (player makes a bet and then is allowed to select a first number of cards or symbols) with redraw or surrender features. In redraw, after the player sees the first set of cards/symbols, the player is offered some redraw value (e.g., points, money) to get a new first set of cards/symbols, that value either added to the player's credit or subtracted from the player's credit). In surrender, after the player sees the first set of cards/symbols, the player is offered some surrender value based upon the value of the cards/symbols to surrender their hand, that value being added to the player's credit. If the player accepts the surrender value the hand is over.

### CROSS-REFERENCE TO RELATED APPLICATION

This application is a continuation-in-part of U.S. patent application Ser. No. 16/939,929 filed on Jul. 27, 2020, which claims the benefit of U.S. provisional application No. 62/886,453 filed on Aug. 14, 2019, the disclosures of which are incorporated by reference.

### FIELD

This invention relates to the field of entertainment and more particularly to a system to administer an alternative version of video poker and other video card games and games of chance.

### BACKGROUND

Video poker originated from mechanical poker. In 1898 a poker machine was introduced that would pay up to 20 coins for a royal flush. Three years later, the first 5-card draw poker machine was introduced that enabled a player to hold one or more of the cards in their hand and then spin the machine again to try and improve it. Seventy years later, poker machines transitioned from a mechanical device into an electronic device employing video displays.

In 1970 the world's first video poker machine was introduced. By 1981, Video Poker was among the most popular gaming machines in casinos. In the late 1990's, “Triple Play Poker” allowed a player to play multiple hands of 5-card draw video poker simultaneously.

Video poker is a single-player game that is played at a VGT (Video Gaming Terminal) or online through a browser or mobile device. Players do not compete against other players. In video poker, players are awarded a payout according to a pre-published payout table for achieving certain five-card poker hands. For example, a player wagering $1.00 who achieves a full house will win $10.00 according to a specific payout table. In video poker, a single wager is placed before the hand is dealt and no table wagering is employed.

Some versions of 5-card draw video poker incorporate a deck that includes some variant of a “wild” (i.e., a 54-card deck that includes two “Jokers” that serve as a wild cards or special cards). Some versions turn an existing card such as a deuce into a wild card whereby that card is used as any other card in the deck, which enables certain hand combinations to be achieved. For example, one popular version is Deuces Wild where all 2's are considered wild cards. In this game format, in a hand that includes two Aces, a six, a nine and a two (deuce), the deuce is counted as an Ace and the hand is credited as having three Aces, resulting in a bigger payout.

Globally, the most popular form of poker is Texas Hold'em. In Texas Hold'em, subsequent cards are not drawn, but rather each player is dealt a fixed number of cards unique to them (“hole cards”) which are then combined with a pre-set number of community cards (cards available to every player). Winning hands are typically determined by taking the best five-card poker hand derived from each player's hole cards combined with the community cards. For example, if a player has an Ace and a King as their hole cards and the five community cards consist of two Aces, a four, a nine and a seven, the player would have three Aces.

Texas Hold'em is typically a multi-player game, typically played at a table by two to ten players. In Texas Hold'em, there are five community cards dealt face down and each player is dealt two hole cards face up. The community cards are then revealed to the players in three sequential stages. In the first stage, commonly referred to as “the flop”, the first three community cards are revealed to the players. In the next stage, an additional single community card, commonly referred to as “the turn” is revealed, and then in the third stage, the final community card, commonly referred to as “the river” is revealed. Rounds of sequential table wagering take place before and after stage. During each round of betting, players make wagering decisions sequentially and have the option to check, call, raise, or fold. Betting order typically flows clockwise around the table of play for at least one rotation. However, several full rotations might occur before a given round is concluded. Normally, players have a limited time to make their betting decisions (i.e., 30 seconds or less to submit a decision or a forced fold is imposed). A single round of wagering might last a single rotation and end in a matter of seconds, or multiple rotations might occur, which can take several minutes to conclude. At the conclusion of all stages and rounds of betting, all remaining players, that is players who have not folded their hands, reveal their cards and the player with the best five-card hand combination from their hole cards and the five community cards wins the pot.

Texas Hold'em and other variations of poker were traditionally played in card rooms. However, in the mid-1990's with the arrival of the Internet, poker games were taken online. The first real money hand in online poker was believed to be held on Jan. 1, 1998. However, the explosive growth, at least in the U.S., was curtailed with the passage of the UIGEA (Unlawful Internet Gambling Enforcement Act), which made online gambling illegal in the U.S. Despite the new regulation, many operators continued to permit U.S. player on their sites. However, on Apr. 15, 2011, commonly referred to as “Black Friday”, the U.S. Department of Justice secured indictments against three of the industry's biggest operators. This effectively curtailed the industry and culminated in the virtual elimination of U.S. players participating in online poker. Nevertheless, online poker continued to thrive outside the U.S.

Despite the fact that online poker is still largely illegal in the U.S., poker still remains extremely popular with most of the U.S. play occurring offline in physical poker rooms. Poker is also quite popular in the rest of the world where it is physically played in numerous poker rooms and through a variety of online poker providers in both regulated and unregulated markets. Additionally, many online poker operators and casino operators have also incorporated various versions of video draw poker into their sites. However, ironically, there is no version of single-player video or online poker that exists in the marketplace today.

In a similar way, slot machines are very popular in casinos and in online gaming. In general, slot machines have several “reels” (or virtual reels) of symbols and paying according to which symbols wind up visible to the player based upon a payout table. Such games have existed for many years and are typically a single “pull” operation—you “pull” the arm (or press a button), the reels spin and stop showing a certain set of symbols, and a payout is made based upon the symbols. There is no provision in today's slot machines for exposing a subset of the reels, taking other actions such as surrendering the reels that you are shown or continuing to spin and score based upon the remaining reels.

What is needed are new versions of video poker or slots that enable such games to be played in a single-player format and provide the player with some measure of control or influence in game play while being fun, fast, easy-to-learn and play. All of this while providing a game structure and format that ensures game integrity, eliminates fraud by either the game operator or players, and provides an independently verifiable mathematical edge to a game operator.

### SUMMARY

Computer-based games such as slots, blackjack, and Texas holdem are disclose including a one-step progression or a two-step progression with options to redraw or surrender the player's hand. In the one-step progression, the player makes a bet and then receives a first set of cards or symbols automatically selected from the full set of cards (deck) or symbols (e.g., slot symbols, dice). In the two-step progression, after making the bet, the player is allowed to select a first number of cards or symbols from a set of cards or symbols pre-selected from the full set of cards (deck) or symbols (e.g., slot symbols, dice). In this way, the player is imparted with the feeling that they have some control as to what cards or symbols they will play with. In some embodiments, after the player sees the first set of cards/symbols, the player will be offered some redraw value (e.g., points, money) to get a new first set of cards/symbols, that value being either positive (added to the player's credit) or negative (e.g., subtracted from the player's credit). In some embodiments, after the player sees the first set of cards/symbols, the player will be offered some surrender value (e.g., points, money) based upon the value of the cards/symbols to surrender their hand, that value being positive (added to the player's credit) as even the worst first set of cards has some chance of winning. If the player accepts the surrender value, the surrender value is added to the player's credit and the hand is over, allowing the player to stop playing (cash-out) or play a completely new hand. Note that the amounts shown as credits include the player's bet, which is returned as the surrender ends the hand.

In one embodiment, a gaming system is disclosed including a game server having an account for recording winnings and losses, a software representation of a set of symbols and a payout table accessible by the game server that includes a payout amount for achieving each of certain combinations of symbols from the set of symbols. The game server displays a user interface that requests a wager and after the wager is entered in the user interface, the game server subtracts the wager from the account then randomly selects a first number of symbols from the set of symbols into a first subset of symbols and displays the first subset of symbols. The game server analyzes the first subset of symbols in real time to determine a combination of the first subset of symbols that yield a highest payout amount from the payout table then the game server calculates a present value of the first subset of symbols, in real time, by: setting the present value to the highest payout amount and then for each possible combinations of a second subset of symbols taken from symbols in the set of symbols, adding to the present value a product of a probability of achieving the second subset of symbols and a payout amount for achieving the first subset of symbols combined with the second subset of symbols from the payout table. The game server sets a redraw offer to the present value minus the wager and displays the redraw offer along with an accept directive and a reject directive. Upon activation of the accept directive, the game server credits the account with the redraw offer, the game server randomly selects the first number of symbols from the set of symbols into the first subset of symbols, the game server displays the first subset of symbols, the game server randomly selects the second subset of symbols from the set of symbols, the game server analyzes the first subset of symbols combined with the second subset of symbols to determine the combination of the first subset of symbols with the second subset of symbols that yields the highest payout amount from the payout table, then the game server credits the account with the highest payout amount; and the game server displays the second subset of symbols, the combination of the first subset of symbols with the second subset of symbols that yield the highest payout amount and the highest payout amount. Upon activation of the reject directive, the game server randomly selects the second subset of symbols from the symbols remaining in the set of symbols and the game server analyzes the first subset of symbols combined with the second subset of symbols to determine the combination of the first subset of symbols with the second subset of symbols that yields the highest payout amount from the payout table, then the game server credits the account with the highest payout amount; and the game server displays the second subset of symbols, the combination of the first subset of symbols with the second subset of symbols that yield the highest payout amount and the highest payout amount.

In another embodiment, a gaming system is disclosed including a game server having an account for recording winnings and losses, a software representation of a set of cards and a payout table accessible by the game server that includes a payout amount for a player hand beating a dealer hand based upon game rules. The game server displays a user interface that requests a wager and after the wager is entered in the user interface, the game server subtracts the wager from the account then the game server randomly selects and moves a first number of cards from the set of cards into the player hand, moves the first number of cards from the set of cards into the dealer hand and moves a second number of cards from the set of cards into a set of community cards and displays a sub-set of the player hand, a sub-set of the dealer hand and a sub-set of the set of community cards. Now, the game server calculates a present value of the player hand, in real time, by: determining a percentage odds that the player hand will beat the dealer hand based on the sub-set of the player hand, the sub-set of the dealer hand and the sub-set of the set of community cards multiplied by a payout for the player hand beating the dealer hand from the payout table and sets a redraw offer to the present value minus the wager. The game server displays the redraw offer along with an accept directive and a reject directive. Upon activation of the accept directive, the game server adds the redraw offer to the account, the game server again randomly selects and moves the first number of cards from the set of cards into the player hand, then the game server displays the player hand, the dealer hand and the set of community cards, then game server resumes game play, which continues until either the player hand or the dealer hand wins which ends the game, then when the player hand beats the dealer hand, the game server credits the account by the amount for the player hand beating the dealer hand plus the wager. Upon activation of the reject directive, the game server displays the player hand, the dealer hand and the set of community cards, then game server resumes game play, which continues until either the player hand or the dealer hand wins, which ends the game, then when the player hand beats the dealer hand, the game server adds the amount for beating the dealer plus the wager to the account.

In another embodiment, a gaming system is disclosed including a game server having an account for recording winnings and losses, a software representation of a set of cards and a payout table accessible by the game server that includes a payout amount for a player hand beating a dealer hand based upon game rules. The game server displays a user interface that requests a wager and after the wager is entered in the user interface, the game server subtracts the wager from the account then the game server randomly selects and moves a first number of cards from the set of cards into the player hand and moves the first number of cards from the set of cards into the dealer hand and displays a sub-set of the player hand and a sub-set of the dealer hand. The game server then calculates a present value of the player hand, in real time, by: determining a percentage odds that the player hand will beat the dealer hand based on the sub-set of the player hand and the sub-set of the dealer hand multiplied by the payout for the player hand beating the dealer hand, sets a redraw offer to the present value minus the wager and displays the redraw offer along with an accept directive and a reject directive. When the accept directive is activated, the game server adds the redraw offer to the account, the game server randomly selects and moves the first number of cards from the set of cards into the player hand. The game server displays the player hand and the dealer hand and resumes normal game play, which continues until either the player hand wins or the dealer hand wins and the game ends. When the player hand wins, the game server adds the amount of the payout for beating the dealer plus the amount of the wager to the account.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates schematic view of a skill gaming system.

FIG. 2 illustrates a typical computer system.

FIG. 3 is a typical initial user-interface for the game format where a player has elected to play five hands simultaneously and three cards are designated as hole cards and each hand being played will be randomly dealt four of the remaining 49 cards as Hole Cards.

FIG. 4 illustrates the user interface in FIG. 3 after the game has started and the three community cards have been dealt face up and in each of the player's five hands, two of its four hole cards have been revealed and each hand has received a cash out offer based on its five available cards and the player has accepted the cash out offer for their first two hands, but elects to not take them for their other three hands and then clicks the reveal button to be shown the remaining two hole cards in each of the hands.

FIG. 5 illustrates the user interface in FIG. 4 after the player has depressed the reveal button and remaining cards are revealed.

FIG. 6 is a typical initial user-interface for a game format in which the player has elected to play five hands simultaneously, bet one credit on each hand and has clicked the deal button to initiate play.

FIGS. 7 and 7B illustrates the user interface in FIG. 6 after two of the five community cards have been picked.

FIG. 8 illustrates the user interface in FIG. 7 after a five by five matrix has been generated to accommodate 25 hole cards that are to be randomly generated.

FIG. 9 illustrates the user interface in FIG. 8 the two selected community cards are placed adjacent to each row, which represents a hand and a payout line.

FIG. 10 illustrates the user interface in FIG. 9 after the 25 randomly generated hole cards have been placed in the slots of the five by five matrix.

FIG. 11 illustrates the user interface in FIG. 10 after each hand of play has been analyzed to reveal that hand's highest five card combination and that hand has been credited with achieving a payout from the payout table and all winning hands have been tallied to produce a total win amount.

FIG. 12 illustrates a sample program flow.

FIGS. 13A-H illustrate a two-step slot game with redraw.

FIGS. 14A-F illustrate a one-step slot game with redraw.

FIGS. 15A-H illustrate a two-step slot game with surrender.

FIGS. 16A-F illustrate a one-step slot game with surrender.

FIGS. 17A-G illustrate a two-step blackjack game with redraw.

FIGS. 18A-F illustrate a one-step blackjack game with redraw.

FIGS. 19A-D illustrate a two-step blackjack game with surrender.

FIGS. 20A-C illustrate a one-step blackjack game with surrender.

FIGS. 21A-F illustrate a two-step Texas-holdem game with redraw.

FIGS. 22A-E illustrate a one-step Texas-holdem game with redraw.

FIGS. 23A-H illustrate a two-step Texas-holdem game with surrender.

FIGS. 24A-C illustrate a one-step Texas-holdem game with surrender.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Throughout this description, an example is made using a gaming system that is similar to the well-known game of poker. It is fully anticipated to implement the same or similar gaming system using solitaire, trivia, board games, etc., having multiple rounds of betting in which each player has an initial asset (e.g. hand) and has a choice to make during the current round, before executing the next round (e.g. the player has the option to surrender their hand for a certain reward before progressing to the next round in which their hand has the possibility of improving and achieving an even higher reward than the surrender offer).

Throughout this description the term player refers to a person who is enjoying the operation of the described system and the operator is a person or entity that provides the described system for the purpose of earning income, either directly from the player in terms of percentages of money bets made by the player or through advertisements that are presented while the player uses the system, or other marketing opportunities.

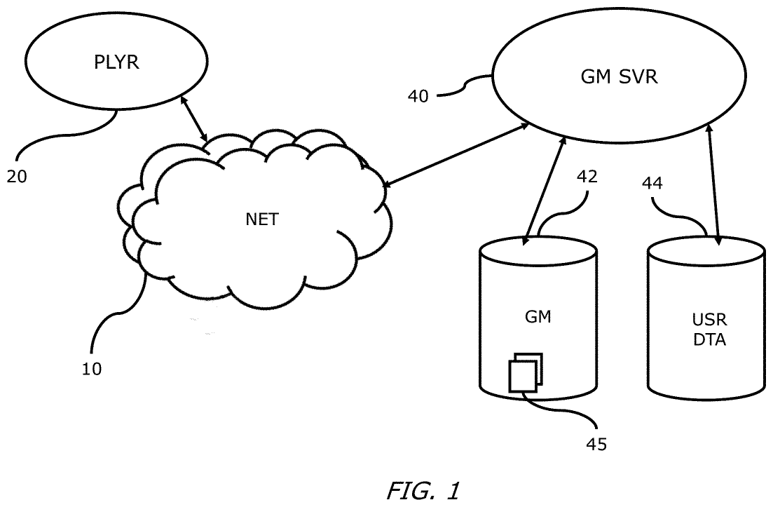

Referring to FIG. 1, a schematic view of a gaming system is shown. One or more client devices 20 (computers, smart phones, etc.) connect to the game server 40 through a network 10, for example, through the Internet. It is assumed that a user of each client device 20 is a player of the game system.

Game details and settings are stored in a game storage area 42 that is accessible by the game server 40, such as, a software representation of the deck of cards 45 (herein to be known as the deck of cards), community cards, each player's hands, number of hands, total amount wagered, etc. The user data 44 includes player data that is accessible by the game server 40 including data such as login credentials, preferences, available funds (user account), name, picture, etc. The deck of cards 45 is a data representation for the cards used by the game being played by the disclosed system. For example, the deck of cards 45 is an array of values from 1-52, each value representing one card (e.g., the value of 0X01 represents the deuce of clubs). It is anticipated that the deck be shuffled before play begins, for example, randomly moving the card values in this array to a different position in the array, or any other shuffling mechanism.

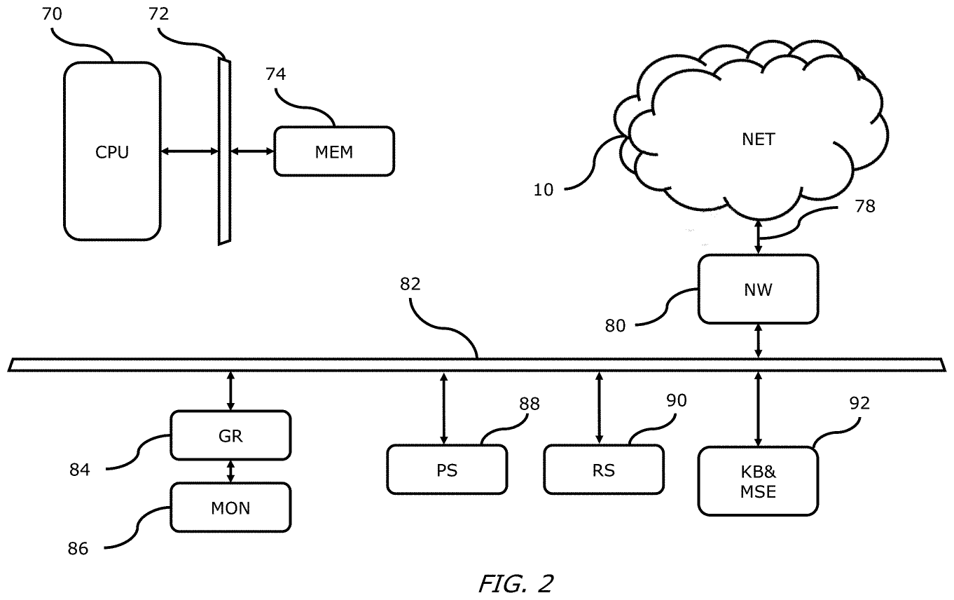

Referring to FIG. 2, a schematic view of a typical computer system operating as the game server 40 or client devices 20 is shown. The example computer system represents a typical computer system used as the game server 40 and/or the client devices 20. The example computer system is shown in its simplest form, having a single processor. Many different computer architectures are known that accomplish similar results in a similar fashion and the present invention is not limited in any way to any particular computer system. The present invention works well utilizing a single processor system, as shown in FIG. 2, a multiple processor system where multiple processors share resources such as memory and storage, a multiple server system where several independent servers operate in parallel (perhaps having shared access to the data), or any combination, etc. In such systems, a processor 70 executes or runs stored programs that are generally stored for execution within a memory 74. The processor 70 is any processor or a group of processors. The memory 74 is connected to the processor, for example, by a memory bus 72 and is any memory 74 suitable for connection with the selected processor 70, such as SRAM, DRAM, SDRAM, RDRAM, DDR, DDR-2, etc. Also interfaced to the processor 70 is a system bus 82, for example, interfacing peripheral subsystems such as a network interface 80, persistent storage 88 (e.g., a hard disk), removable storage 90 (e.g. DVD, CD, flash drive), a graphics adapter 84 and a keyboard/mouse 92, etc., to the processor 70. The graphics adapter 84 receives commands and display information from the system bus 82 and generates a display image that is displayed on the display 86.

In general, the persistent storage 88 is used to store programs, executable code and player data such as player financial data in a persistent manner. The removable storage 90 is used to load/store programs, executable code, images and data onto the persistent storage 88.

These peripherals are examples of persistent storage 88 and other examples of persistent storage devices 88 include core memory, flash memory, etc. Other examples of removable media storage 90 include CDRW, DVD, DVD writeable, Blu-ray, SD cards, other removable flash media, floppy disk, etc. In some embodiments, other devices are connected to the system through the system bus 82 or with other input-output connections/arrangements as known in the industry. Examples of these devices include printers; graphics tablets; joysticks; and communications adapters such as modems and Ethernet adapters.

The network interface 80 connects the computer-based system to the network 10 through a link 78 which is, preferably, a high-speed link such as a cable broadband connection, a Digital Subscriber Loop (DSL) broadband connection, fiber optics, etc.

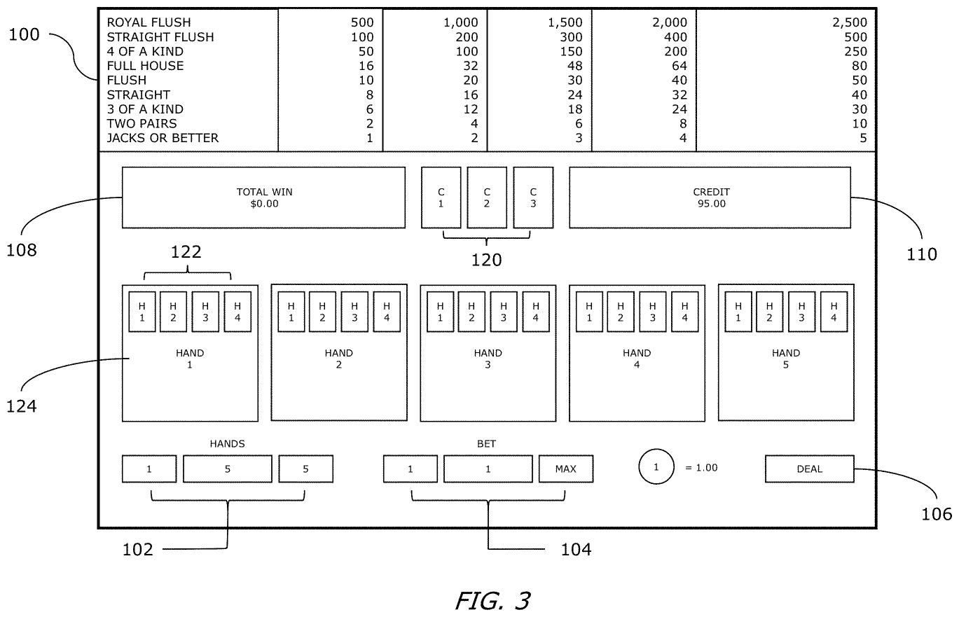

The game server 40 maintains a representation of a deck of cards 45 (e.g., a set of cards from a standard poker deck, represented electronically) and during a game. In one game, the software running on the game server 40 randomly selects the community cards 120 from the deck of cards 45 (see FIG. 3), eliminating the community cards 120 from the deck of cards 45. Then, the software running on the game server 40 randomly selects each hole cards 122 for each player from the remaining cards in the deck of cards 45. As the game progresses, the game server 40 presents user interfaces as described later showing the community cards 120, collects bets from the client devices 20, presents surrender options, etc. As each round of the game is made, the software running on the game server 40 delivers one or more of the hole cards 122 to the client devices 20 for display to the player for making decisions as to whether to proceed to the next phase (possibly requiring additional payments), accepting a surrender value for their hand(s), etc.

FIG. 3 represents a typical initial user-interface for the game format where there are three community cards 120 and two of each hand's 124 hole cards 122 that will be displayed face up and considered each hand's available cards. In this example, there are five hands 124 being played.

A payout table 100 for achieving certain combinations of cards, in this example, for achieving certain combinations of cards in a 5-card poker hands is displayed. The player selects the number of hands to play using a number-of-hand selector 102 and the player selects an amount to wager per hand by a wager selector 104 (e.g., an amount of credits wagered per hand). Once the number of hands and the wager have been selected by the player, the deal button 106 is depressed to initiate game play.

Note that the payout table 100 shown in FIG. 3 and other figures is a sample and, depending upon the return desired by the operator, the payouts are adjusted up or down as appropriate. For example, the payout for a royal flush is 500 for a single bet and 2500 for a bet of 5, but some operators might choose to increase the payout for a royal flush for a bet of 5 to a higher amount, say 5000, to encourage the player to make the maximum bet. Further, in some embodiments, more than five cards are considered in the payout table 100. For example, there is a very slight possibility that one would achieve a seven-card royal flush (A, K, Q, J, 10, 9, 8 of the same suit) and the payout for such a low-probability hand be set to a very high value such a 1,000,000 or more.

The user-interface also includes a win notification box 108 and a credits box 110.

For each hand being played, there is a hand 124 in a display area that includes the hole cards 122 of the player.

In this example, the player, who started with 100.00 credits, has elected to play five hands, each with a wager of 1 credit. The player operates the deal button 106 and the game is initiated. The credits box 110 then displays 95.00 to reflect the 5.00 credits wagered (one for each hand).

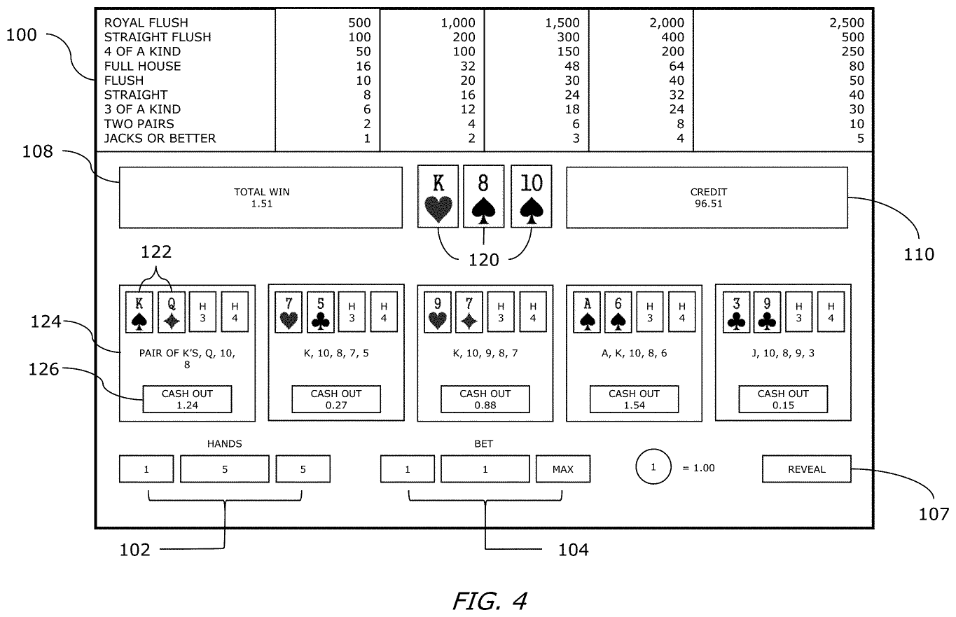

FIG. 4 represents the typical user interface above, after the game has started. The community cards 120 and two of each hand's 124 hole cards 122 are shown face up in their designated areas. Each hand's message area now displays the hands best 5-card combination and a cash out offer button 126 showing the cash out offer amount for the hole cards 122 that are face up in combination with the community cards 120.

In this example, it is shown that the player operates the cash out offer button 126 for the first two hands. Responsive to this, the win notification box 108 shows 1.51 as the sum of the cash out offers is 1.51. In addition, the credits box 110 is updated 96.51 to reflect the current credits plus the win of 1.51 from the cash out offers. The player then operates the reveal button 107 to reveal the remaining cards for each hand. Not that since the player previously accepted the cash out offer for the first two hands, those hands will not be awarded further credit, even if a better hand of the payout table is achieved as those hands have been surrendered.

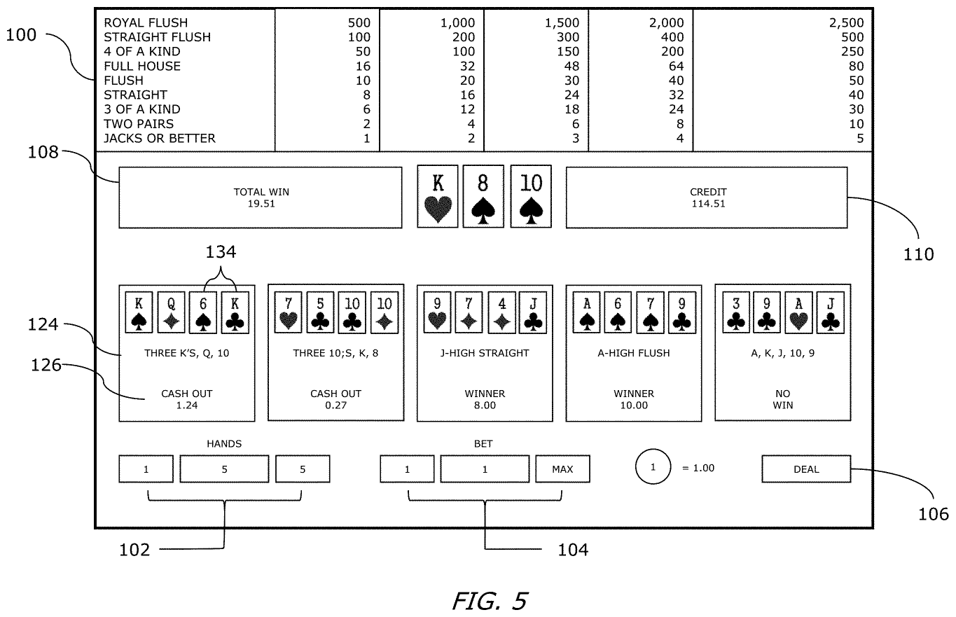

Referring to FIG. 5, the user interface from above is shown after the two remaining hole cards 134 for each hand have been revealed. The message area of each hand 124 is updated to display the best 5-card combination of each hand 124 including the four hole cards 122 combined the three community cards 120, seven available cards. Note that in some embodiments, the display area of the hand 124 is updated for hands that have been surrendered, even though they are not eligible for additional payout. Each message area now includes either the cash out offer amount that was accepted of the amount the hand is awarded according to the payout table. Since one of the hands produced a straight and another of the hands produced a flush, winnings of 8.00 and 10.00 are added to the player's credits and shown in credits box 110 (now 114.51). The win notification box 108 shows 19.51 which is the sum of the cash out offers that were accepted (1.51) plus the two winning hands (18.00).

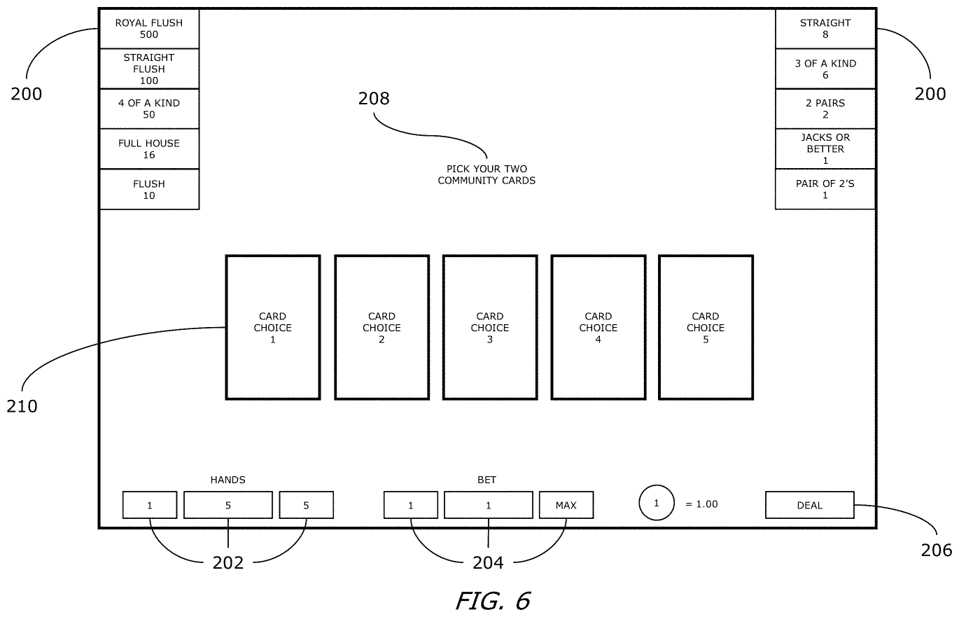

Referring now to FIG. 6, a user interface for another game format is shown. In this example, there is a second payout table 200 for achieving certain five-card poker hand combinations, a hand 210, a number-of-hand selector 202 a wager selector 204 and a deal button 206. Note that the second payout table 200 is an example and is typically based upon the number of total cards in the deck (e.g., 52 cards or 54 cards), the total cards provided to the player per hand, and the advantage desired by the game operator.

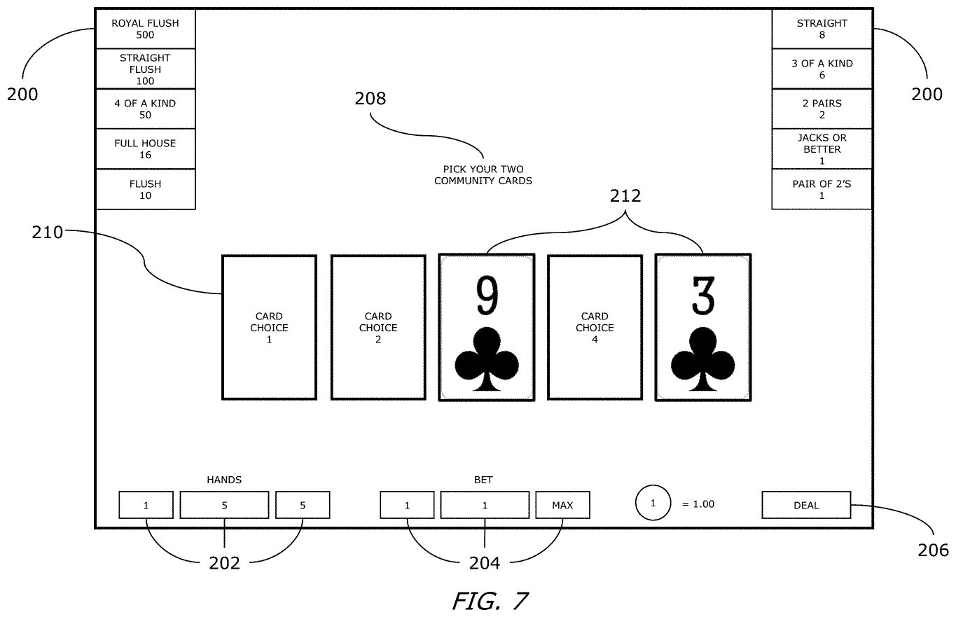

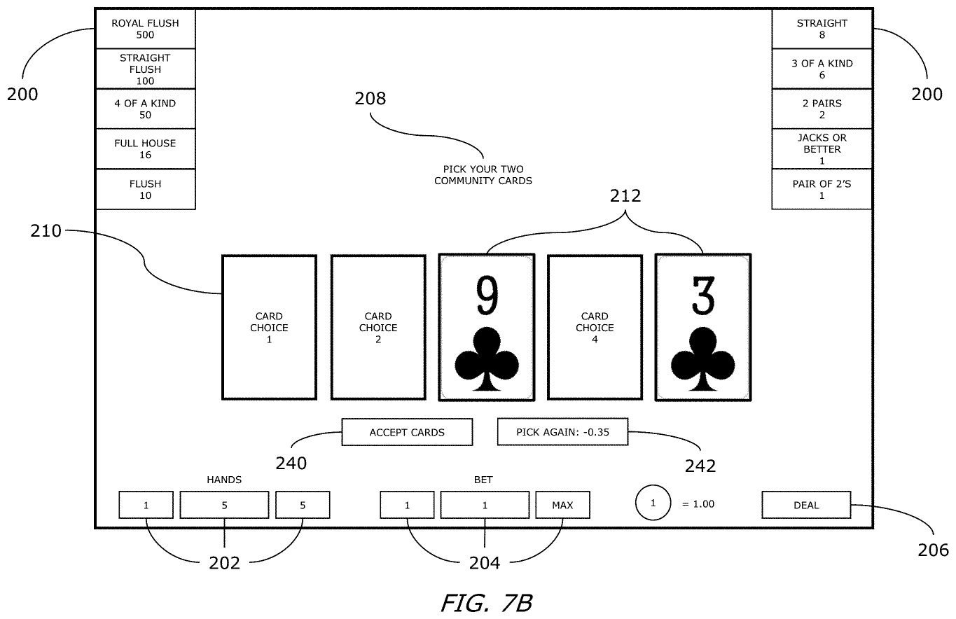

In the example shown in FIG. 6, the player selects to play five hands with a wager of one credit for each hand. Five cards are randomly drawn from the deck of cards 45 and presented face down in the hand 210. The player is instructed by a message 208 to pick two of the five cards of the hand 210 and the player has selected two cards to be the base community 212 as shown in FIG. 7 (the player selected the third and fifth card of the hand 210. In this example, the player finds the 9 and 3 of clubs, which will become the base community cards 212 of the player. Note that in some embodiments, the player does not have the option to select two cards and the base community cards are automatically selected for the player.

In some embodiments, or game formats, the five community cards of the hand 210 are displayed face up and the player the selects the number of cards allowed knowing what cards are available. For example, if the set of five community cards of the hand 210 that displayed face up include A-Spades, A-Diamonds, 9-Hearts, 10-Hearts, Jack-Hearts and the number of cards to select is three, the player has to decide if it is better to keep the pair of aces and one of the other cards or the three cards of the same suit in a row.

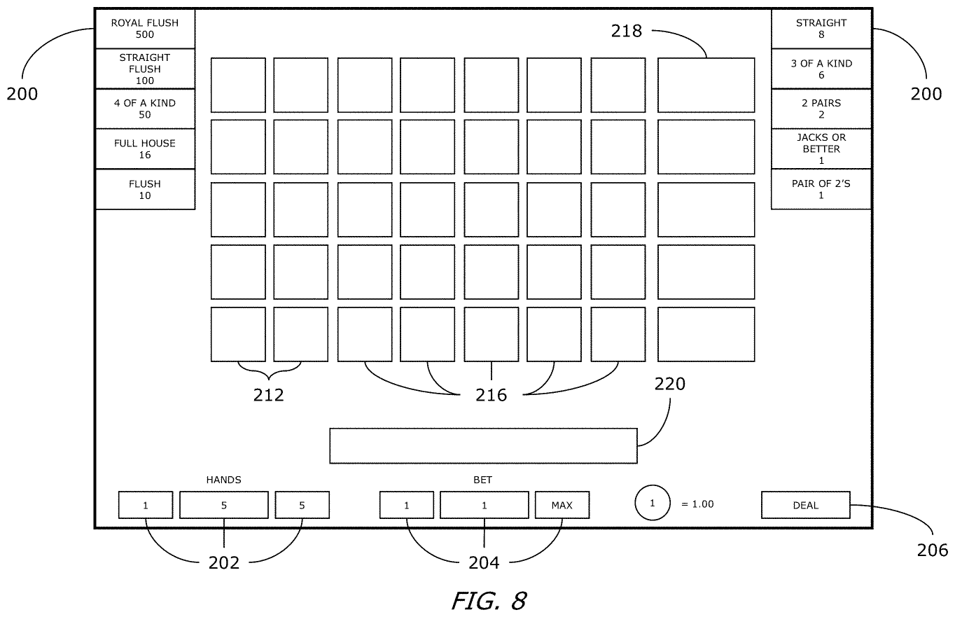

In some embodiments of playing, after seeing the base community cards 212, the player selects the deal button 206, play proceeds to that of FIG. 8. In some embodiments of playing as shown in FIG. 7B, after seeing the base community cards 212, the player is provided options to accept the base community cards 212 by selecting the “accept cards” option 240 or to redraw by selecting the “pick again” option 242. If the player selects the “accept cards” option 240, play resumes to that shown in FIG. 8. If the player selects the “play again” option 242, the amount of money shown (e.g. in the “pick again” option 240, which is the redraw offer, is added for each hand being played (e.g. in the example of FIG. 7B, for five hands, so −0.35×5, or −1.75 is added, or in essence, subtracted) from the player's account as shown in the credits box 110 and play reverts back to that shown in FIG. 6 with a new set of community cards of the hand 210 randomly drawn from the deck of cards 45.

In some embodiments, the redraw offer (e.g., amount collected for the “pick again” option 242) is a fixed amount that is less than the wager such as 0.50 as shown in FIG. 7B. In such, the player pays the redraw offer and gives up any chances of winning from the base community cards 212 that were selected, and in return, the player must continue with the player being required to pick two new cards as the base community cards 212. This is called a redraw, as the player pays the redraw offer or redraw amount, but continues the hand with new base community cards 212. In other words, the player pays the fixed amount in addition to the amount already bet using the wager selector 204.

In another embodiment, instead of a fixed amount for the redraw offer, the redraw offer is calculated as a cash out or surrender value of the present cards. In this embodiment, the surrender value is calculated by adding the highest payout value of the first set of cards to the sum of the probabilities of winning each payout in the second payout table 200 in view of the selected base community cards 212, then subtracting the wager. For example, a 10-Spades and J-Spades will provide a greater redraw offer than a 4-Hearts and 9-Diamonds. In such, it is anticipated that for some game combinations, the redraw offer (e.g. surrender value) will be greater than the wager or bet, as for example, if the base community cards 212 are a pair of aces, this guarantees a payout of at least 1.00 for each hand, so in such, a surrender value will be a positive amount that is higher than the wager while a 9-3 off suit may only have a surrender value of 0.70 and therefore the redraw offer will be the wager-surrender value or, negative 0.30. For the pair of aces, if the redraw offer (e.g., surrender value) is 1.75 and the wager is 1.00, the player will be credited with the difference (e.g. 0.75). In some embodiments, the redraw offer (e.g., surrender value) is neutral, providing no advantage to the operator of this game. In some embodiments, the redraw offer (e.g., surrender value) is biased, preferably to the advantage of the operator of the game. For example, the redraw offer (e.g., surrender value) is calculated as above, then multiplied by a discount value, where a discount value of 1.0 retains the neutral redraw offer (e.g. surrender value). In games that include the calculated redraw offer (e.g. surrender value) instead of a fixed redraw offer (e.g. −0.35), after surrendering the hand, play resumes to either that of FIG. 6, in which the player can walk away from the game without playing another hand or the that of FIG. 7 or where the player is already in the next hand (paying the bet) and selecting a new set of base community cards 212.

In another embodiment, the game is blackjack. The player receives two cards from the deck of cards 45 and the dealer also receives two cards from the deck of cards 45, one of which is exposed for the player to see. After seeing the player's two cards and one card of the dealer, the player is presented a redraw option (e.g., “pick again”) for a certain cost (e.g., the redraw offer) and if the player is not happy with their two cards in view of the dealer's exposed card, the player accepts the redraw option and the redraw offer is deducted from the players account. In this scenario, the dealer's cards are not changed, but the player receives two new cards from the deck of cards 45. In some embodiments, the above is repeated one or more times. In some embodiments, the player's two cards are replaced into the deck of cards 45 before the player receives the two new cards, meaning that it is possible for the player to receive back one or both cards that were discarded.

Referring to FIG. 8, a transitional user interface is shown. After the community cards have been selected, a blank card matrix (e.g., face down) is generated with columns for the base community cards 212 and hole cards 216. In this example, each row is a hand. To the right of each hand is a message box 218 for that hand. Winnings are shown in the winnings box 220.

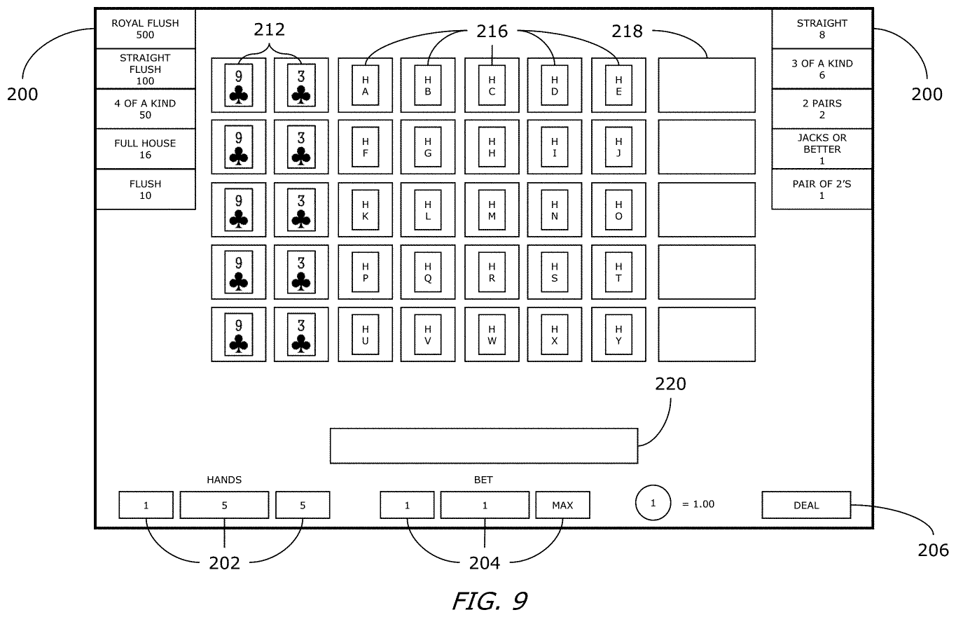

Referring to FIG. 9, the user-interface of FIG. 8 is shown, except the base community cards 212 are now shown (each hand receives the same base community cards 212). There are 25 hole cards 216 displayed face down so the player does not know the value for each hole card 224.

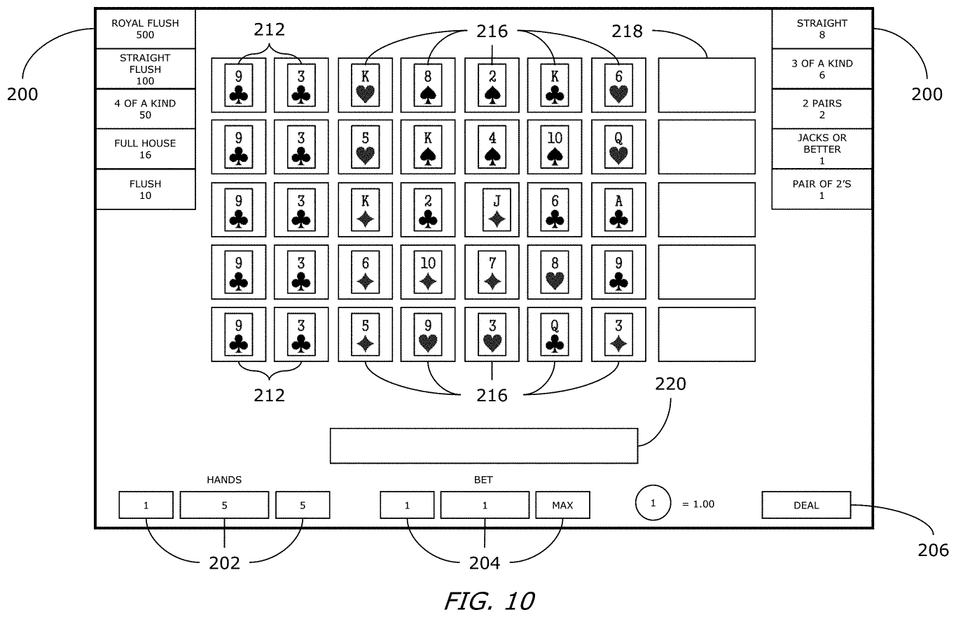

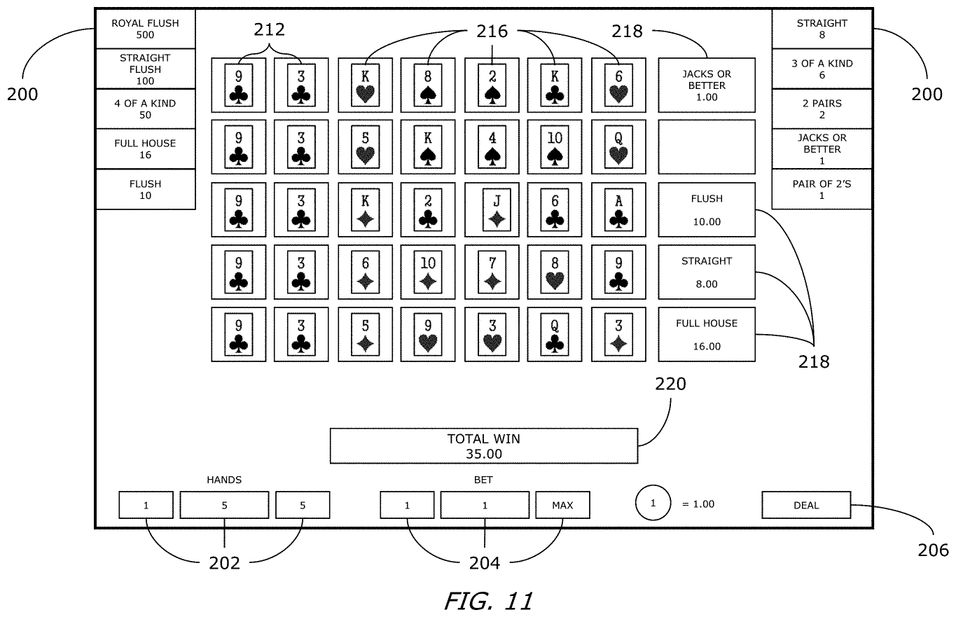

Referring to FIG. 10, the above-described user-interface is shown with the hole cards 216 exposed (e.g., displayed face up). Now winnings are calculated based upon the best n cards in each hand including each row of base community cards 212 and hole cards 216 with respect to the second payout table 200. The winnings, if any, are then displayed in the message box 218 as shown in FIG. 11. Each hand is analyzed to determine its best n card poker combination (in some embodiments, n is five, though in some embodiments, n is six or seven for greater numbers of poker combinations). If the hand(s) is/are awarded a payout, as displayed in the message box 218 for that hand, the total win for all hands is calculated and displayed in the winnings box 220. The player can operate the deal button 206 to play the game again.

In all embodiments having a surrender value (or cash out value), the surrender value of the player's initial hand is either a fixed amount, a fixed amount plus the highest payout amount of the player's initial cards from the payout table, or is calculated as the sum of the probabilities of all possible winning hands times the payout for that hand plus the highest payout amount of the player's initial cards from the payout table. As an example, that illustrates this process, consider a simplified hand of five cards in which four cards are exposed and there is one more card left hidden from the player. For simplicity, also consider the payout table 100 of FIG. 4 as payouts.

In this example, the exposed cards are A-Spade, K-Spades, Q-Spades, J-Spades. Note that the highest payout amount of the player's initial cards from the payout table in this example is zero as there are no pairs or any other combination noted in the payout table. As the exposed cards are A-Spade, K-Spades, Q-Spades, J-Spades, then the following fifth cards will provide a winning hand according to the payout table 100: 10-Spades (royal flush) 2/3/4/5/6/7/8/9-Spades (flush), 10-Clubs (straight), 10-Diamonds (straight), 10-Hearts (straight), and the following cards will produce a hand of jacks or better: A-Clubs, A-Diamonds, A-Hearts, K-Clubs, K-Diamonds, K-Hearts, Q-Clubs, Q-Diamonds, Q-Hearts, J-Clubs, J-Diamonds, and J-Hearts. As an example, given the player has A-Spade, K-Spades, Q-Spades, J-Spades; the probability of the next card being the 10-Spades is 1 out of 52-4 or 1 out of 48, which is 0.0208. The payout for a royal flush is 500, so the probability of receiving the 10-Spades as the fifth card contributes 0.0208*500 to the sum, or approximately 10.41. The contribution to the sum by any of the other three tens would be 3*0.0208, resulting in a straight. The payout for a straight is 8, so these fifth cards contribute 3*0.0208*8, or 0.50. The contribution to the sum by any of the other spades would be 8*0.0208, resulting in a flush. The payout for a flush is 10, so these fifth cards contribute 8*0.0208*10, or 1.67. There are twelve cards that will result in a pair. The contribution to the sum by any of these cards would be 12*0.0208, resulting in a pair. The payout for a pair is 1, so these fifth cards contribute 1*0.0208*1, or 0.25. Therefore, given the player has A-Spade, K-Spades, Q-Spades, J-Spades, the sum of the above calculated surrender values is 10.41 (straight flush)+0.50 (straight)+1.67 (flush) and 0.25 (pair), plus a highest payout amount of 0.0, totaling 12.83. Therefore, in a game of 4 cards+1 card, if the player has A-Spade, K-Spades, Q-Spades, J-Spades; a neutral surrender value is 12.83 credits for a 1.00 credit bet.

For some hands, the surrender value is the same as the highest payout amount because there is no chance of improving the hand. For example, if the player has A-Spade, A-Hearts, A-Diamonds, A-Clubs, then the fifth card cannot improve the player's hand and the surrender value is the same as the highest payout amount, which is 50 per the payout table 100. In a similar way, even though the fifth card can improve some hands, the improved hand will not achieve a payout. Take for example 2-Clubs, 3-Clubs, 4-Diamonds, 9-Hearts. The only possible improvement is to obtain a pair of 2s, 3s, 4s, or 9s, which do not impart a payment according to the payout table 100 and, therefore, the surrender value is zero as there is no payment unless the player achieves at least Jacks or better.

The surrender value is calculated either by brute force or by using root combinations. Brute force requires evaluation of the hand with each possible other card to determine the payout for each, then the payout for each is multiplied by the probability of getting that card, which is 1 out of 52-4 in the example above, or 0.0208. This method requires high amounts of computational power as given each of the remaining 48 hands, the best hand out of the cards must be calculated, then that best hand used to determine the payout according to the payout table 100.

Instead, it is possible to use root combinations to pare down the total space and utilize tables that are generated based upon the payout table. For example, if the player has A-K-Q-J and these are not of the same suit, there is no chance of getting a flush, only 3 chances of getting a straight and 12 chances of getting a pair. Therefore, first determining if there is a secured payout (e.g., if the player has A-A-J-J, there is a secured payout of 2 for two pair according to the payout table 100. In as much as it makes no difference which two pairs are found, a table can be constructed that is indexed by each unique combination of initial hands that can result in a secured payout and or a payout based upon the fifth card. Therefore, by evaluating the initial hand into categories (e.g. assigning four of a kind to category-9, three of a kind to category-8, a pair to category-7, four cards in sequence to category-6, four cards in sequence except for an inside card to category-5, four cards of the same suit to category-4, three cards that are higher than a 10 to category-3, two cards that are higher than a 10 to category-2, one card that is higher than a 10 to category-1, etc., a smaller table is constructed that is indexed by the hand category. The hand is evaluated one time (e.g., A-A-A-J is evaluated to category 8 or 2-2-2-J is also evaluated to category 8), then the entry in the table for category 8 would be the secured payout for that hand which is 6.00 for three of a kind per the payout table 100 plus the payout for a full house times the probability of a full house (0.0208*3*16 or 1.00) plus the payout for four of a kind times the probability of four of a kind (0.0208*1*50 or 1.04). Therefore, by performing a quick evaluation of the hand comprising the first four cards to determine a category and looking up that category in a table, it is quickly determined that the surrender value of that hand (e.g., A-A-A-J) is 6.00+1.00+1.04, or 8.04, assuming that the operator of the game remains neutral on whether the hand is surrendered or not. If the operator of the game desires extra income from those who surrender, then the surrender value is discounted by the added margin desired. For example, if the operator desires an extra 1% advantage when a player surrenders their hand, the calculated or looked-up surrender value is discounted by that advantage, so if the surrender value for A-A-A-J is 8.04, if the game operator desires an additional 1% advantage, the surrender value provided to the player for this hand will be 8.04*(1−0.01) or 7.96.

Note that the above examples have been explained in view of one of the simplest poker games of five cards, four initial cards and one final card that is revealed after either surrendering or continuing play without surrendering. The math of probabilities as well as number of permutations and table sizes increases greatly with the number of cards and with the number of unknown cards at the time of deciding on surrendering. For example, given a five-card game in which the player sees three cards and must decide whether to surrender before seeing the next two cards, there are many more combinations of possible outcomes based upon three cards then one card as above. Likewise, the number of permutations increases greatly as the total number of cards increases such as in the game described in FIG. 3 through FIG. 5 having a total of seven cards per hand.

It is fully anticipated that the game operator provides the surrender value without an additional advantage being that the game operator is already benefiting by the advantage provided by the payout table. For example, if one sums the probabilities of obtaining each hand in the payout table by the payout for that hand, the total comes to less than one, usually somewhere between 0.93 and 0.96 meaning that, on average, for each hand played, the game operator pays back 0.93 to 0.96 for each 1.00 bet.

The above-described games are shown utilizing an electronic representation of a single deck of playing cards. Electronic representation of decks of playing cards are known in the industry, including the standard 52 card, four suit deck as often used to play poker, a 52 card deck plus one or two jokers, a 24 card deck as used in Euchre, a deck of cards as used in Uno®, a deck representing tarot cards, or any deck of cards in which different hands (subsets of the cards) result, all of which are anticipated and included herein. Further, the above games are described having a single deck of n card, though it is fully anticipated that multiple decks be employed, for example, one deck for each hand.

Additionally, the above-described games are based upon poker hands, though there is no limitation to only poker or to standard payout tables. For example, it is anticipated to apply the above disclosed technology to any type of game. One example is “Scrabble® where the player is provided some number of letter tiles (electronically selected randomly and displayed) and the player will receive another number of letter tiles after a surrender offer is made and the player makes a decision as to whether to surrender or not, the payouts and surrender value made based upon the best scoring word that can be made from the full set of letter tiles.

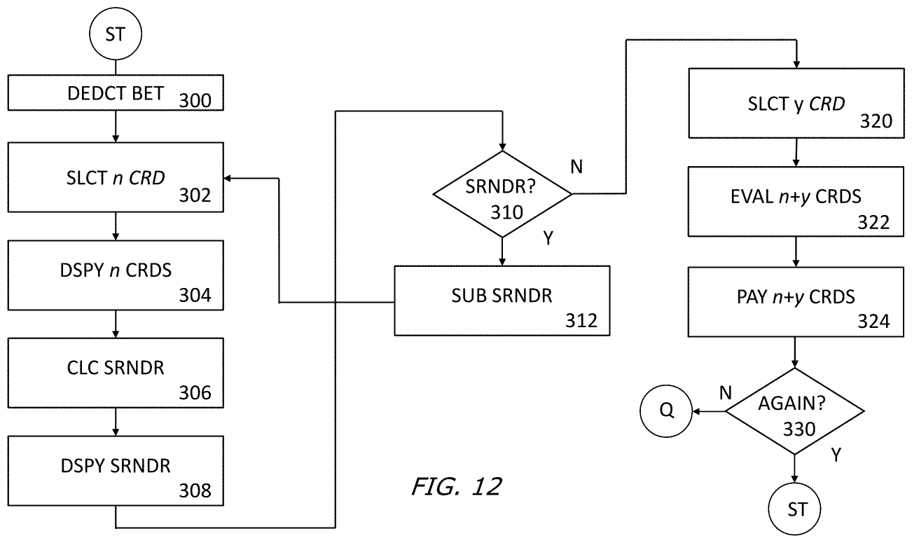

Referring now to FIG. 12, a sample program flow of the above games is shown. The sample program flow is shown for playing a single hand at a time, though any number of hands played simultaneous are anticipated. Flow starts with deducting the bet 300 from the player's account. For example, subtracting one unit (e.g., one dollar, one point, one Euro) from the amount of credit that the player currently has in their account. Next n cards are randomly selected 302 from the deck and displayed 304 to the player. A surrender value is calculated 306 as described above and the surrender value is displayed 308 to the player. If the player accepts the surrender 310, the surrender value is deducted from the player's account and play continues with selecting new cards 302-310. In some embodiments, the player is presented with only one opportunity to surrender.

If the player does not accept the surrender 310, the next set of y cards are randomly selected 320 from the deck and the hand consisting of the first set of n cards and the second set of y cards is evaluated 322 for the best possible winning combinations and the payment 324 based upon the best possible winning combination is paid by adding the payment 324 to the player's account. Next, the player decides to play again 330, restarting the above, or, if not, quitting.

The above noted cash out and/or redraw functions are equally applicable to other games such as other card games like Pai Gow, three-card poker, Black Jack, etc., in which the player opposes the house (has to beat a hand or hands that the dealer has). In such, the player receives a number of cards, as does the dealer, and the player makes decisions with those cards and/or receives subsequent cards. In any case, it is anticipated that after receiving the initial set of cards and, in some embodiments such as Black Jack, seeing part of the dealer's hand, the player will be presented with either a cash-out offer or a re-draw offer. For example, in Pai Gow, after the player receives seven cards, the player must arrange the cards into a two-card hand and a 5-card hand before the dealer shows any cards. After receiving the seven cards, the game is able to calculate the probability of beating both the dealer's two-card hand and the dealer's five-card hand and the probability of a tie (only beating one of the dealer's hands) and, use that probability to offer a cash-out offer (e.g., 0.88 for a 1.00 bet if the player's hand is very good or 0.05 if the player's hand is not very good). In a similar way, the player is offered a re-draw for a fee, say $0.50. If the player accepts the re-draw fee, the player gets seven new cards. In Black Jack, the player and dealer each get two cards then the player decides whether to stay, split, take a hit, double down, etc. In some embodiments, when the player receives the initial two cards, the player is presented with a re-draw offer and if accepted, the player pays the requested amount and gets two new cards (the dealer's cards remain the same). In another embodiment, at each stage in which the player has a possible decision, the game is able to calculate the probability of beating the dealer's two-card hand (e.g. the card that is showing and any other random card remaining in the deck) and, use that probability to offer a cash-out offer (e.g., 0.88 for a 1.00 bet if the player's two cards are good and the dealer's exposed card is bad or 0.05 if the player's two cards are not very good and/or the dealer's exposed card is strong). In such, if the player does not accept the cash-out offer (for example, the player has two aces and the dealer has an 8), the player has the option to take additional cards, to double down, to split into two hands (additional ante may apply), etc. After the player takes any of these actions, it is anticipated (optionally) that another cash-out offer be made, etc., until the player either busts (hand totals over 21) or the player stands, at which the dealer's second card is exposed and it is determined whether the dealer wins, player wins, or a draw.

Although described with respect to card games, the redraw offer and/or cash-out offer is anticipated for any other type of game played either individually or against the dealer. For example, games including tiles or dice such as Yahtzee®, Bingo, Keno, Scrabble®, etc. As an example, in Keno®, the player decides a number of picks he/she will make from one through 20, then picks that many numbers from the range of numbers in the game. For example, in a game having a range of numbers from 1-75 and the player picks five numbers: 7, 11, 15, 22, and 30. The game system then randomly selects, typically, twenty numbers in the range of numbers and if the game selects the numbers selected by the player (or in some games, a subset of the numbers selected by the player), the player wins a prize based upon the number of correct numbers. In a cash-out version of Keno, it is anticipated that after a certain quantity of numbers have been selected by the game (e.g., after 10 numbers are selected), the probabilities of each payout to the player is calculated and the player is offered a cash-out amount proportional to the predicted payout and, if accepted, receives the cash-out amount and if not selected, the next ten numbers are selected to see if the player wins based upon the standard win calculations. Likewise, in craps, the player makes a bet and rolls the dice. If the player doesn't roll a certain combination of the dice (craps or natural), the player has a point to meet in successive rolls of the dice. In such, the game calculates the probability of the player winning based upon the point and presents a cash-out offer.

In the following descriptions, a one-step progression includes the player making a bet, then receiving a first set of cards or symbols automatically selected from the full set of cards (deck) or symbols (e.g., slot symbols, dice). A two-step progression includes the player making a bet, then selecting a first number of cards or symbols from a set of cards or symbols pre-selected from the full set of cards (deck) or symbols (e.g., slot symbols, dice). In this way, the player is imparted with the feeling that they have some control as to what cards or symbols they will play with. For example, believing that if they select the second symbol, it will be a 777.

In the following descriptions, the term redraw indicates that, after the player sees the first set of cards/symbols, the player will be offered some redraw value (e.g., points, money) to get a new first set of cards/symbols, that value being either positive (added to the player's credit 110) or negative (e.g., subtracted from the player's credit 110). Note that in all games, it is anticipated that after the player accepts the redraw offer, either the player must play the subsequent cards/symbols or another redraw offer is made and so fourth. The term surrender indicates that, after the player sees the first set of cards/symbols, the player will be offered some surrender value (e.g., points, money) to surrender their hand, that value being positive (added to the player's credit 110) as even the worst first set of cards has some chance of winning. If the player accepts the surrender value, the surrender value is added to the player's credit 110 and the hand is over, allowing the player to stop playing (cash-out) or play a completely new hand. Note that the amounts shown as credits include the player's bet, which is returned as the surrender ends the hand.

In the following descriptions, example user interfaces for a slot game, blackjack game, and Texas holdem game are shown. These user interfaces are shown as examples and, as such, it is fully anticipated that the same or similar functionality be provided in similar or different user interfaces without veering from the present application.

Note that although not shown on all of the following user interfaces, it is anticipated that each game includes multiple hands or sets of slot reels, allowing the player to play multiple hands/reels concurrently.

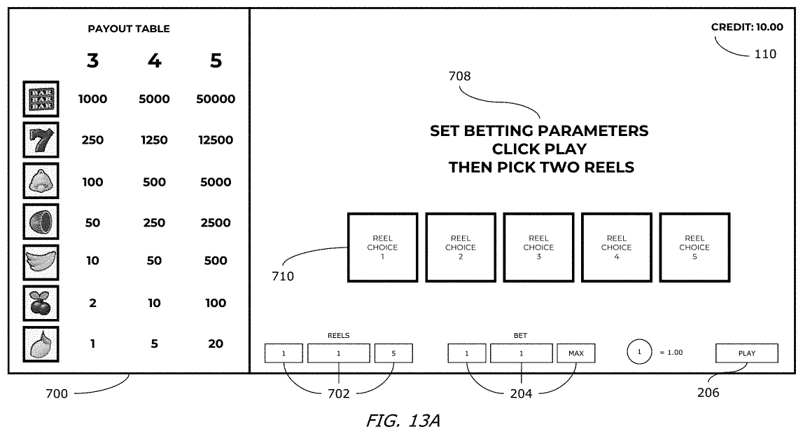

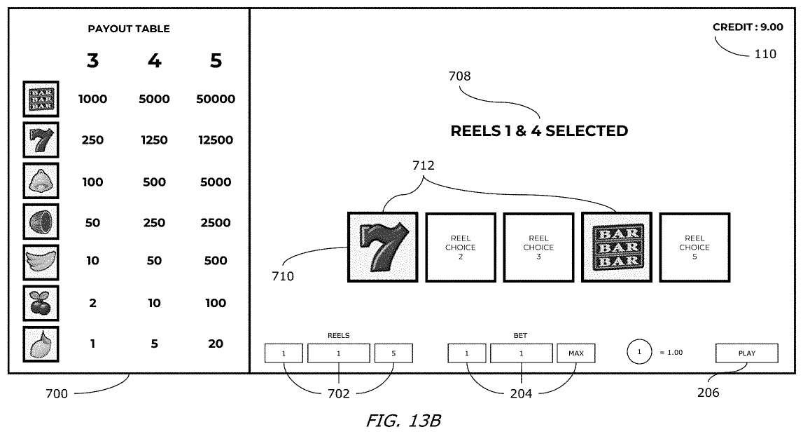

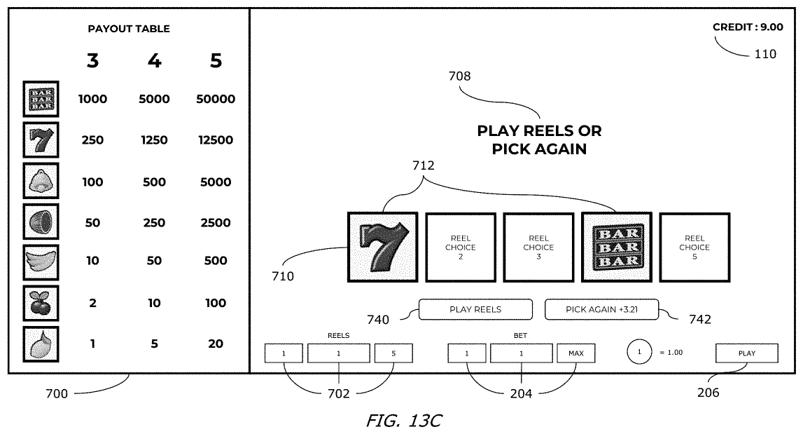

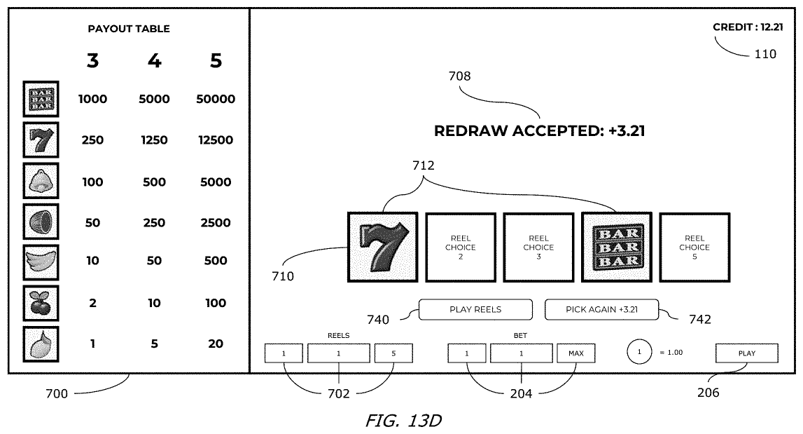

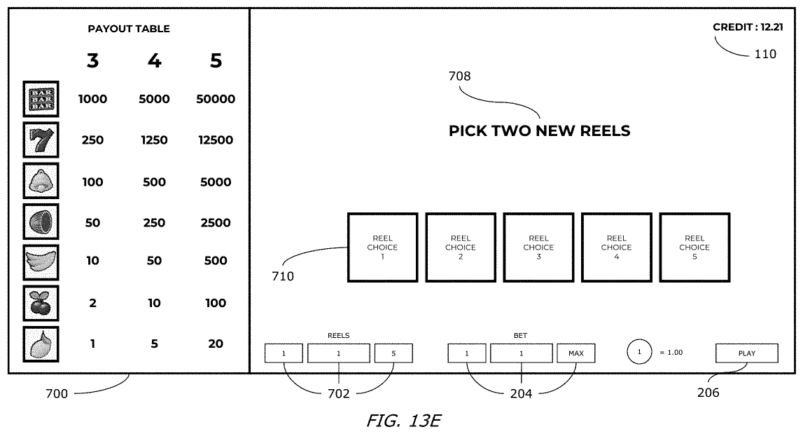

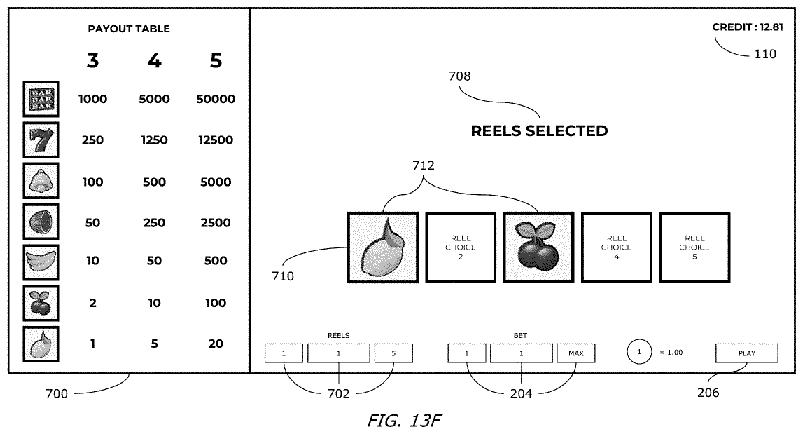

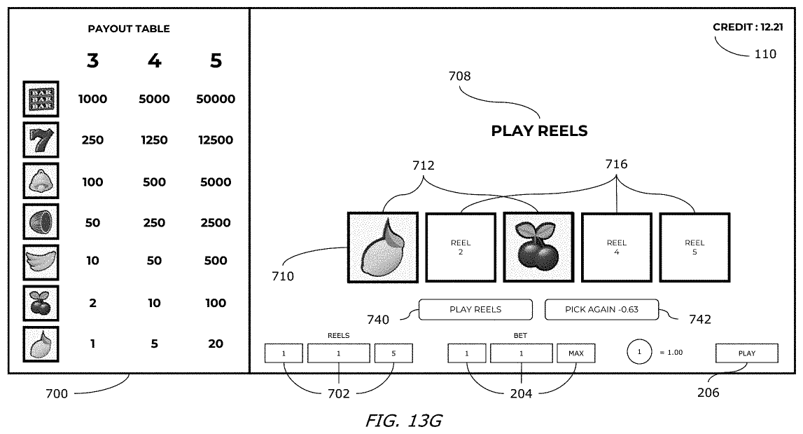

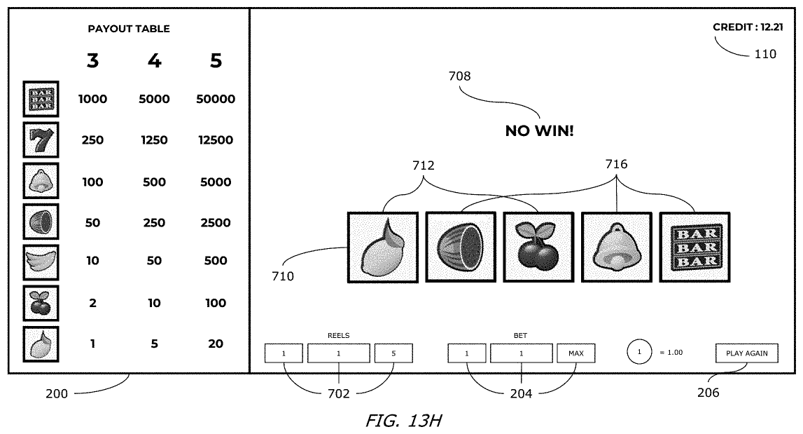

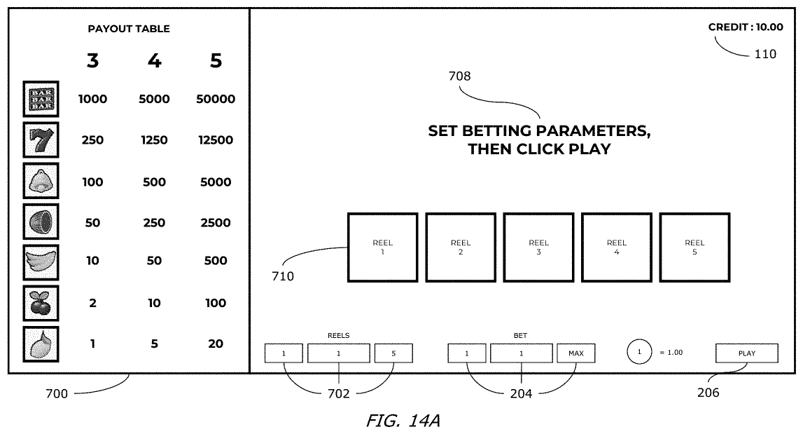

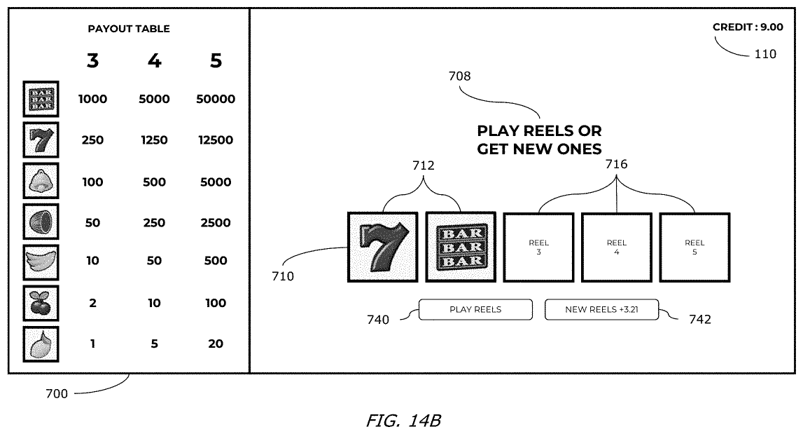

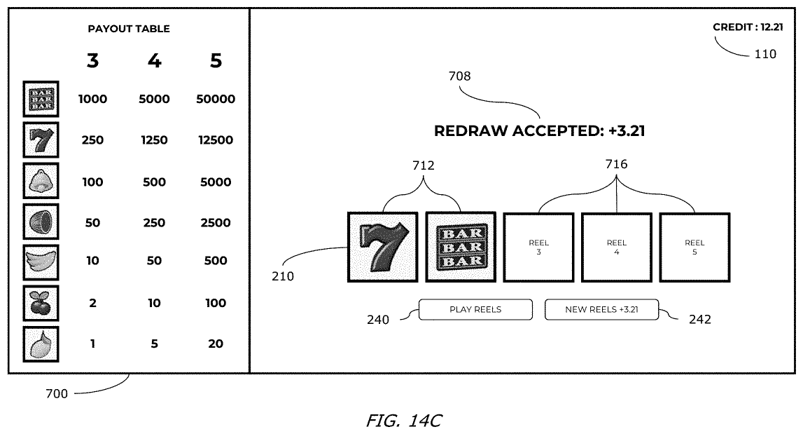

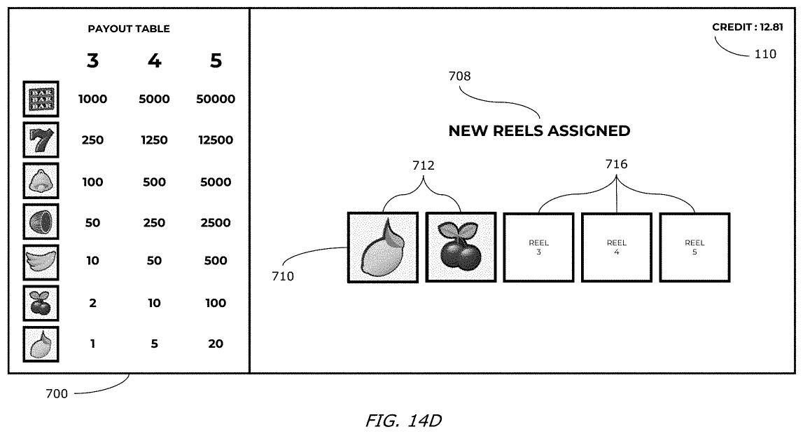

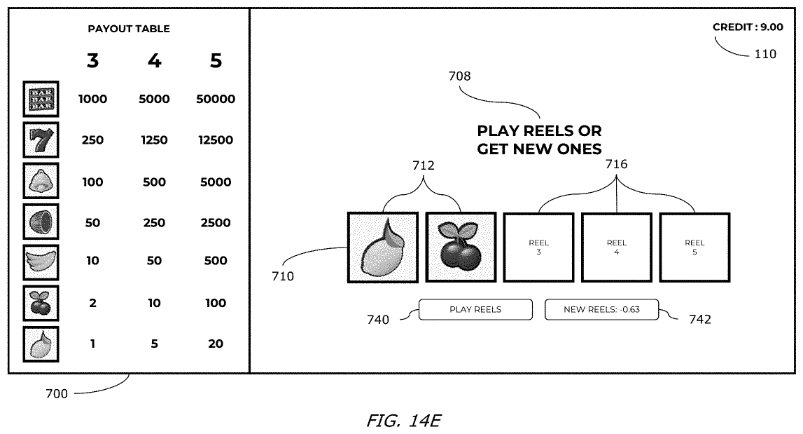

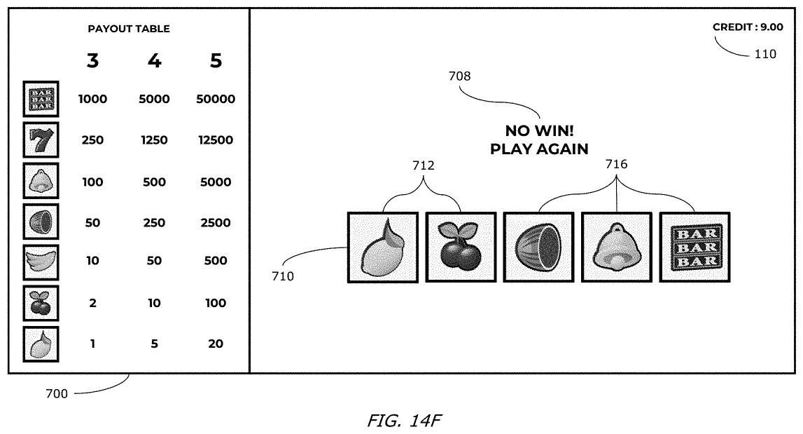

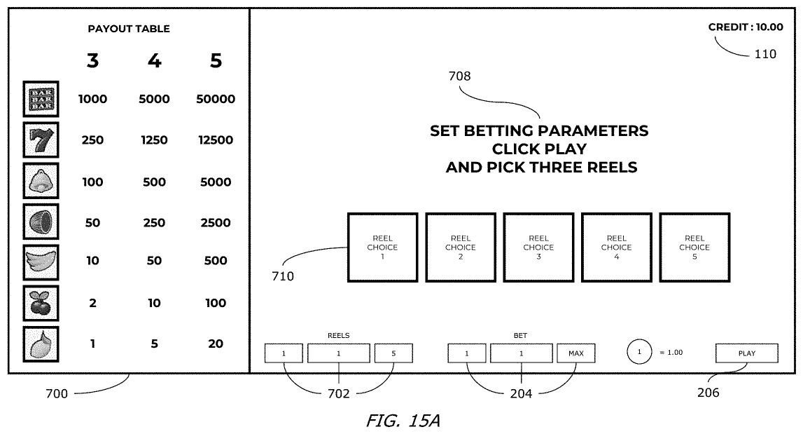

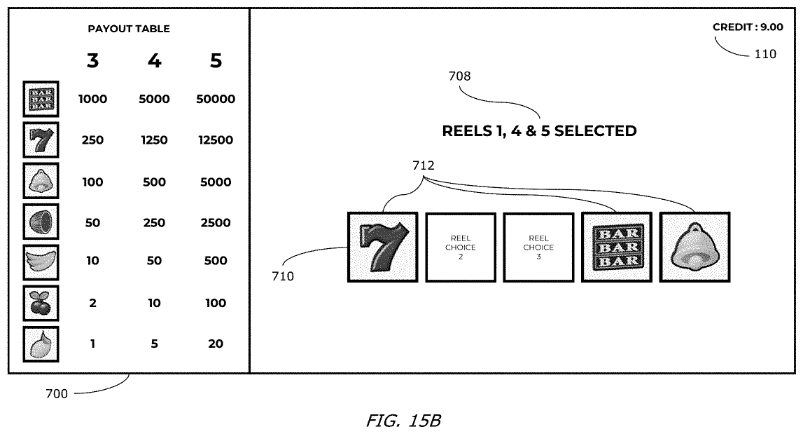

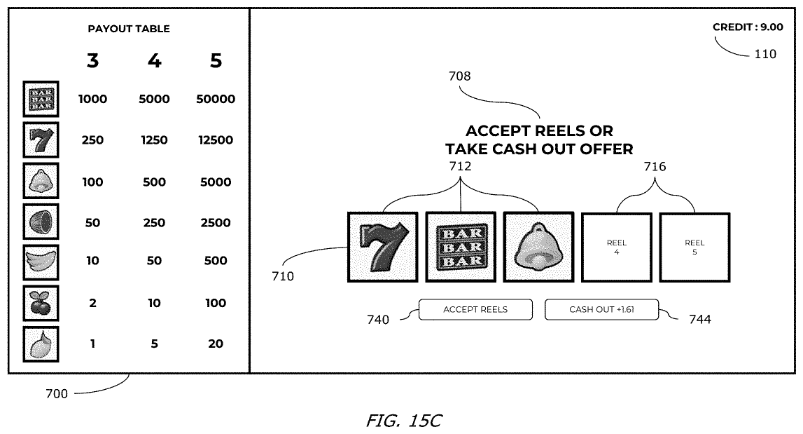

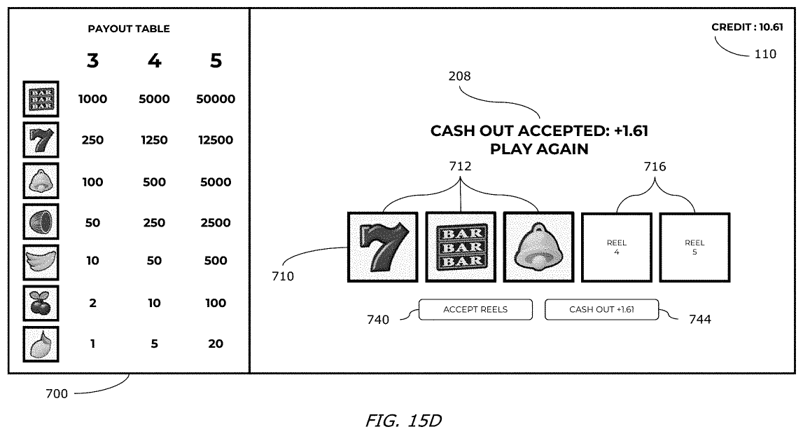

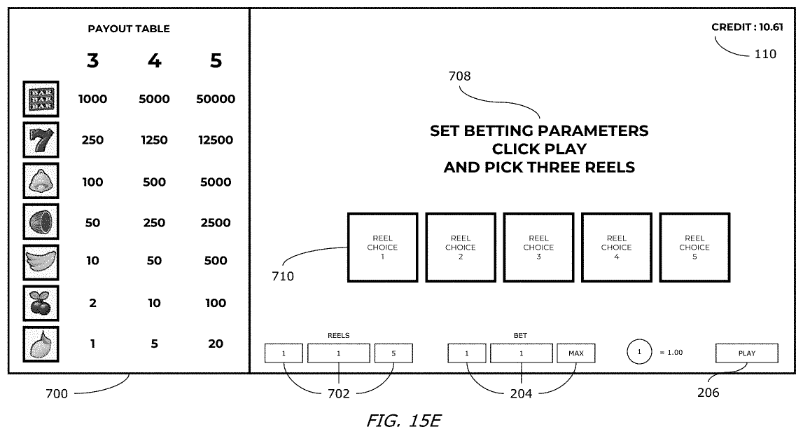

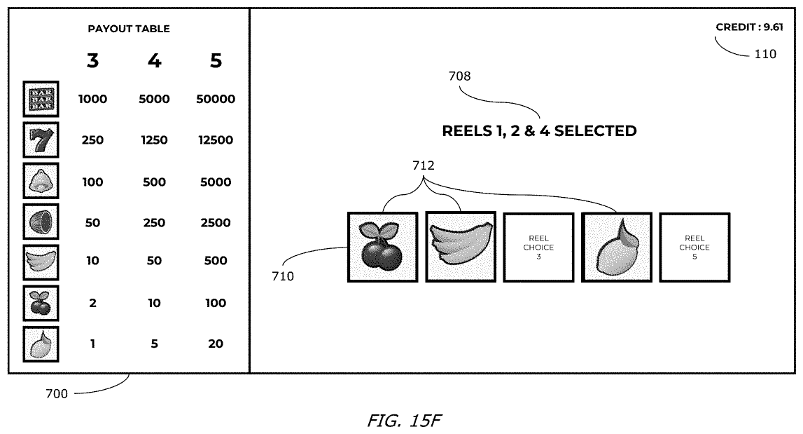

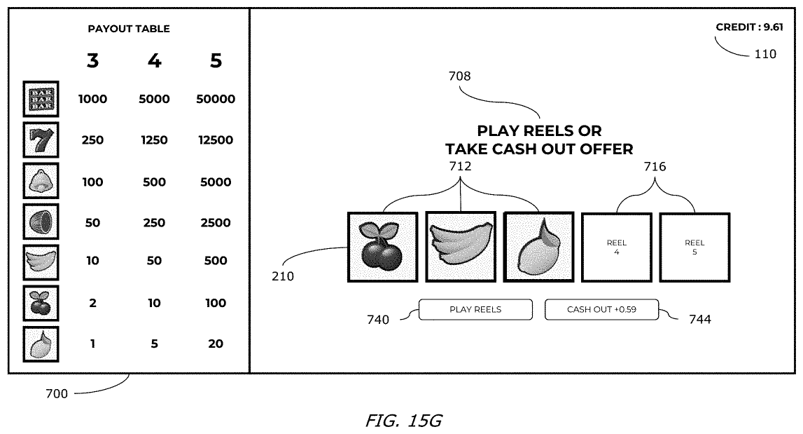

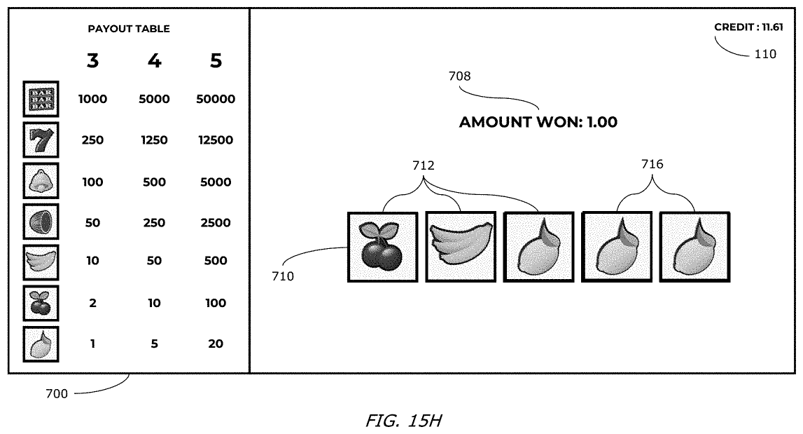

Referring to FIGS. 13A-H, 14A-F, 15A-H, and 16A-F, forms of a slot game are shown with one-step progressions (FIGS. 14A-F and 16A-F), two step progressions (FIGS. 13A-H and 15A-H), with redraw (FIGS. 13A-H and 14A-F) and/or with surrender (FIGS. 15A-H and 16A-F) also called “cash-out.”

In FIG. 13A, an initial user interface for the two-step slot game with redraw is shown including a title 708, a payout table 700, a credit box 110 showing funds/points available to the player. The player adjusts the number of reels with a reel selector 702 (e.g., for playing multiple games at one time) and adjusts their bet using a wager selector 204. Once the player is ready, the player starts the slot game using the deal button 206 (e.g., play button). In FIG. 13A, the slot symbol boxes 710 are blank until the player selects a number of the slot symbol boxes 710. Note that at some time from the beginning of the game until any or all of the slot symbol boxes 710 are revealed, a random slot symbol (e.g., 777, cherries, bell, lemon) are assigned to each of the slot symbol boxes.

After selecting the deal button 206, the user interface of FIG. 13B is displayed. Note that the player's bet has been deducted from the credit box 110. Initially, the slot symbol boxes 710 are blank until the player selects a number of the slot symbol boxes 710, in this example, two of the slot symbol boxes 710 are selected, now two icons 712 are shown (7 and triple-bar).

Now, a present value of the two icons 712 is calculated based upon the probability of each other possible icon being present in the remaining set of slot symbol boxes 710 (in this case three). For example, one possible combination is three “7” icons, the payoff for which is 250 and another possible combination is four “7” icons, the payoff for which is 1250. The present value is calculated based upon the probability of achieving any entry in the payout table 700 times that corresponding payout amount. Again, as an example, if the probability of a “7” icon, or p(7) is 0.02, then the contribution to the payoff amount based upon the payout table 700 would be p(7)*p(7)*250 (three “7” icons)+p(7)*p(7)*p(7)*1250 (four “7” icons) since one “7” icon is already present. This payoff value is 0.11. Additionally, three or four “triple-bar” possibilities need be considered as well as three “bells,” three “oranges,” three “bananas,” three “cherries,” and three “lemons,” as the three remaining spaces are capable of having any of these symbols. In FIG. 13C, the player is then presented with a redraw offer 742, in this example, +3.21, and if the redraw offer is accepted, 3.21 is added to the player's credit as shown in FIG. 13D and the credit box 110 in the user interface of FIG. 13E now shows the total of 9+3.21, or 12.21. The current game continues where the player gets to pick two new symbol boxes 710.

Note that in any of the two-step games, it is fully anticipated that after accepting the redraw offer, the player is presented with the ability to select their icons (as in FIG. 13E) or the icons are automatically selected for the player. The player is still in the same game but in the user interface of FIG. 13E is offered new icon boxes 710, in which the player has selected the first and third of the icon boxes 710 as the two icons 712 and a “lemon” icon and a “cherry” icon is now displayed in FIG. 13F. The present value of the “lemon” icon and a “cherry” icon are calculated as above and, this time, the redraw offer 742 is −0.63 due to the lower value of these symbols is displayed in FIG. 13G. In this example, the player selects play reels 740 which results in revealing the remaining symbols 716 being revealed in FIG. 13H and an evaluation is made as to the winnings, if any, based upon the payout table 700 in conjunction with the five symbols, the two icons 712 and the now revealed final icons 716. In this example, as there are no set of three or more of the same symbols, there is no win.

In FIG. 14A, an initial user interface for the one-step slot game with redraw is shown including a title 708, a payout table 700, a credit box 110 showing funds/points available to the player. The player adjusts the number of reels with a reel selector 702 (e.g., for playing multiple games at one time) and adjusts their bet using a wager selector 204. Once the player is ready, the player starts the slot game using the deal button 206 (e.g., play button). In FIG. 14A, the slot symbol boxes 710 are blank until the player selects the deal button 206. Note that at some time from the beginning of the game until any or all of the slot symbol boxes 710 are revealed, a random slot symbol (e.g., 777, cherries, bell, lemon) are assigned to each of the slot symbol boxes.

After selecting the deal button 206, the user interface of FIG. 14B is displayed. Note that the player's bet has been deducted from the credit box 110. Initially, the slot symbol boxes 710 are blank until the player selects the deal button 206, in this example, two of the slot symbol boxes 710 are automatically revealed and now two icons 712 are shown (7 and triple-bar).

Now, a present value of the two icons 712 is calculated based upon the probability of each other possible icon being present in the remaining set of slot symbol boxes 710 (in this case three). For example, one possible combination is three “7” icons, the payoff for which is 250 and another possible combination is four “7” icons, the payoff for which is 1250. The present value is calculated based upon the probability of achieving any entry in the payout table 700 times that corresponding payout amount. Again, as an example, if the probability of a “7” icon, or p(7) is 0.02, then the contribution to the payoff amount based upon the payout table 700 would be p(7)*p(7)*250+p(7)*p(7)*p(7)*1250 since one “7” icon is already present. This payoff value is 0.11. Additionally, three or four “triple-bar” possibilities need be considered as well as three “bells,” three “oranges,” three “bananas,” three “cherries,” and three “lemons,” as the three remaining spaces are capable of having any of these symbols. The player is then presented with a redraw offer 742, in this example, +3.21, and if the redraw offer is accepted, 3.21 is added to the player's credit as shown in FIG. 14C and the credit box 110 in the user interface of FIG. 14C now shows the total of 9+3.21, or 12.21.

The game now continues as shown in FIG. 14D with new values assigned to each slot symbol boxes 710 and the two icons 712 are automatically revealed as this is a one-step game, showing a “lemon” icon and a “cherry” icon. Again, the present value of the “lemon” icon and a “cherry” icon are calculated as above and, this time, the redraw offer 742 is −0.63 as shown in FIG. 14E, due to the lower value of these symbols. In this example, the player selects play reels 740 which results in revealing the remaining symbols 716 being revealed as shown in FIG. 14F and an evaluation is made as to the winnings, if any, based upon the payout table 700 and the five symbols, the two icons 712 and the now revealed final icons 716. In this example, as there are no set of three or more of the same symbols, there is no win.

In FIG. 15A, an initial user interface for the two-step slot game with surrender is shown including a title 708, a payout table 700, a credit box 110 showing funds/points available to the player. The player adjusts the number of reels with a reel selector 702 (e.g., for playing multiple games at one time) and adjusts their bet using a wager selector 204. Once the player is ready, the player starts the slot game using the deal button 206 (e.g., play button). In FIG. 15A, the slot symbol boxes 710 are blank until the player selects a number of the slot symbol boxes 710 (e.g., the two-step process). Note that at some time from the beginning of the game until any or all of the slot symbol boxes 710 are revealed, a random slot symbol (e.g., 777, cherries, bell, lemon) are assigned to each of the slot symbol boxes.

After selecting the deal button 206, the user interface of FIG. 15B is displayed. Note that the player's bet has been deducted from the credit box 110. Initially, the slot symbol boxes 710 are blank until the player selects a number of the slot symbol boxes 710, in this example, three of the slot symbol boxes 710 are selected, now three icons 712 are shown (7, triple-bar, and bell).

Now, a present value of the three icons 712 is calculated based upon the probability of each other possible icon being present in the remaining set of slot symbol boxes 710 (in this case two). For example, one possible combination is three “7” icons, the payoff for which is 250 and another possible combination is three “triple-bar” icons, the payoff for which is 1000. The present value is calculated based upon the probability of achieving any entry in the payout table 700 times that corresponding payout amount. Again, as an example, if the probability of a “7” icon, or p(7) is 0.02, then the contribution to the payoff amount based upon the payout table 700 would be p(7)*p(7)*250 since one “7” icon is already present. This payoff value is 0.1. Additionally, three “triple-bar” possibilities and three “bell” possibilities need be considered as the two remaining spaces are capable of having any of these symbols. In FIG. 15C, the player is then presented with a surrender offer 744, in this example, +1.61, and if the surrender offer 744 is accepted, 1.61 is added to the player's credit as shown in FIG. 15D and the credit box 110 in the user interface of FIG. 15D now shows the total of 9+1.61, or 10.61. The current game is now finished and the player is offered to play a new game in FIG. 15E.

As in FIGS. 15A-15D, the user interface of FIG. 15E offers betting options and new icon boxes 710, in which after the player has set the parameters, clicked the play button 206. In FIG. 15F, the player the credit box 110 shows 9.61 reflecting a debit for the 1 credit bet for this round and the player has selected the first, second, and fourth of the icon boxes 710 as the three icons 712 and a “cherry” icon, “banana” icon, and a “lemon” icon are now displayed. In FIG. 15G, the present value of the “cherry” icon, “banana” icon, and a “lemon” icon are calculated as above and, this time, the surrender offer 744 is +0.59 due to the lower value of these symbols as displayed. In this example, the player selects play reels 740 which results in revealing the remaining symbols 716 being revealed in FIG. 15H and an evaluation is made as to the winnings, if any, based upon the payout table 700 in conjunction with the five symbols, the three icons 712 and the now revealed final icons 716. In this example, three of the same symbol (“lemon”) are achieved and, there is a win amount of 1 based upon the payout table 700, and 2 credits (1 for the return of the bet and 1 for the win) are added to the credit box 110, now showing 11.61.

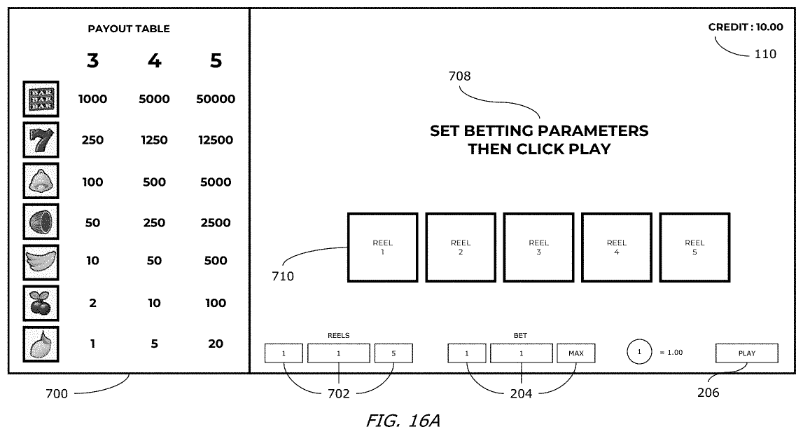

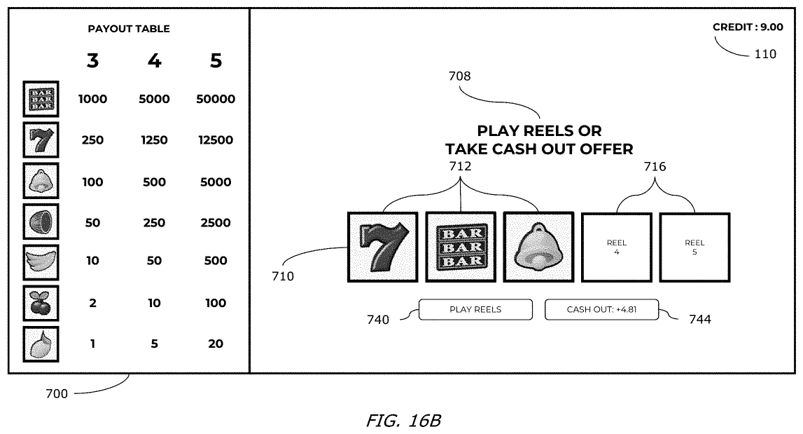

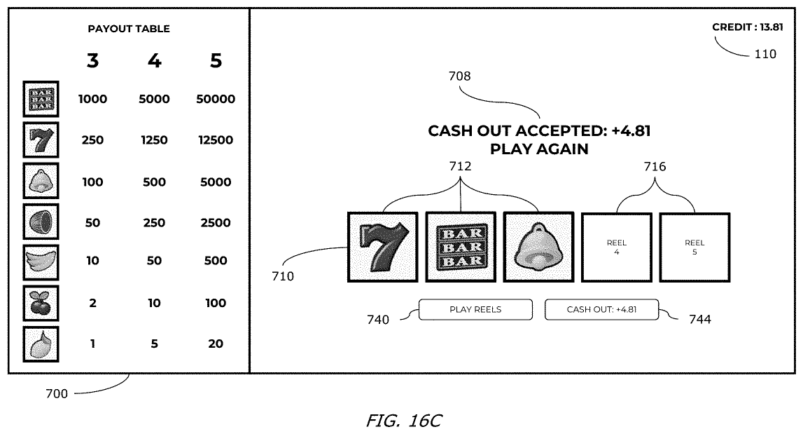

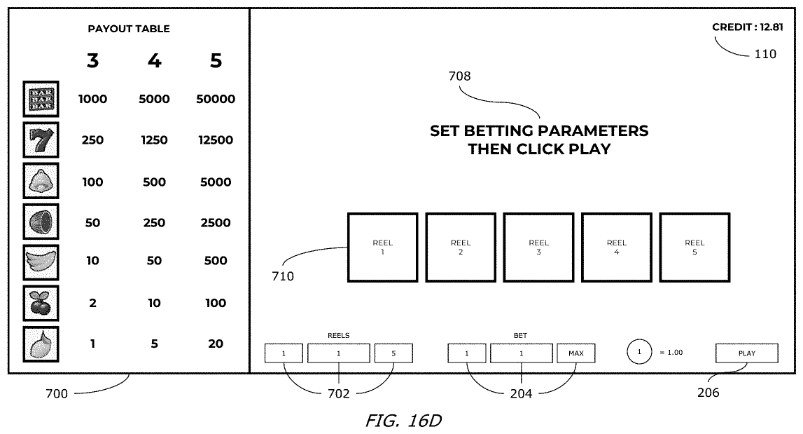

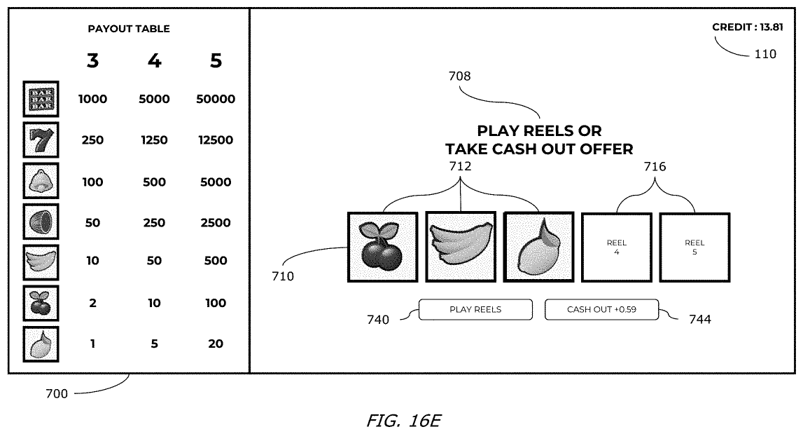

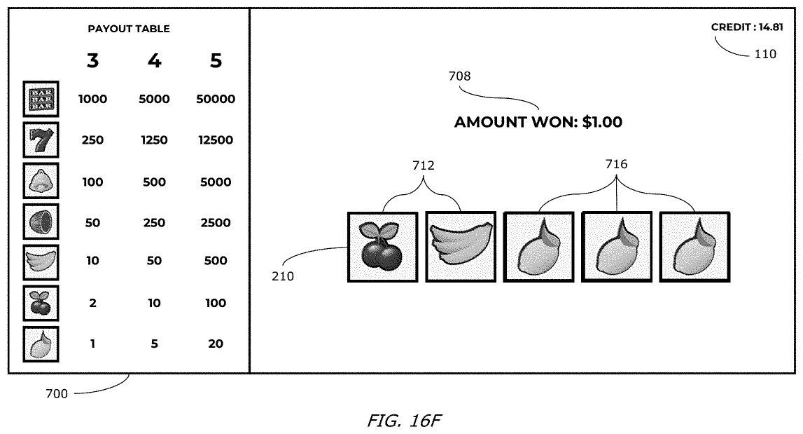

In FIG. 16A, an initial user interface for the one-step slot game with surrender is shown including a title 708, a payout table 700, a credit box 110 showing funds/points available to the player. The player adjusts the number of reels with a reel selector 702 (e.g., for playing multiple games at one time) and adjusts their bet using a wager selector 204. Once the player is ready, the player starts the slot game using the deal button 206 (e.g., play button). In FIG. 16A, the slot symbol boxes 710 are blank until the player selects the deal button 206. Note that at some time from the beginning of the game until any or all of the slot symbol boxes 710 are revealed, a random slot symbol (e.g., 777, cherries, bell, lemon) are assigned to each of the slot symbol boxes.

After selecting the deal button 206, the user interface of FIG. 16B is displayed. Note that the player's bet has been deducted from the credit box 110. Initially, the slot symbol boxes 710 are blank until the player selects the deal button 206, in this example, three of the slot symbol boxes 710 are automatically revealed and now three icons 712 are shown (7, triple-bar, bell).

Now, a present value of the three icons 712 is calculated based upon the probability of each other possible icon being present in the remaining set of slot symbol boxes 710 (in this case three). For example, one possible combination is three “7” icons, the payoff for which is 250. The present value is calculated based upon the probability of achieving any entry in the payout table 700 times that corresponding payout amount. Again, as an example, if the probability of a “7” icon, or p(7) is 0.02, then the contribution to the payoff amount based upon the payout table 700 would be p(7)*p(7)*250 since one “7” icon is already present. This payoff value is 0.11. Additionally, three “triple-bar” possibilities and three “bell” possibilities need be considered as the two remaining spaces are capable of having any of these symbols. The player is then presented with a surrender offer 744, in this example, +4.81, and the surrender offer 744 is accepted, 4.81 is added to the player's credit as shown in FIG. 16C and the credit box 110 in the user interface of FIG. 16C now shows the total of 9+4.81, or 13.81. The game is now over and the player can quit or play another game as shown in FIG. 16D.

A new game now starts as shown in FIG. 16D with new values assigned to each slot symbol boxes 710 and after betting is finished and the deal button 206 (play) is selected and the amount of the bet (1) is debited from the credit box (110). In FIG. 13F the three icons 712 are automatically revealed as this is a one-step game, showing a “7” icon, a “triple-bar” icon and a “bell” icon. Again, the present value of the “7” icon, a “triple-bar” icon and a “bell” icon are calculated as above and, this time, the surrender offer 744 is +0.59 as shown in FIG. 16E, due to the lower value of these symbols. In this example, the player selects play reels 740 which results in revealing the remaining symbols 716 being revealed as shown in FIG. 16F. In this example, three of the same symbol (“lemon”) are achieved and, there is a win amount of 1 based upon the payout table 700, which, along with the player's bet, is added to the credit box 110, now showing 14.81.

Note that although a traditional “slot” format is disclose in which the player must achieve a set of symbols that appear in the payout table 700, it is equally anticipated that the format be slightly different in which there is a dealer who is provided two symbols that are hidden from the player until redraw/surrender is complete and the goal is not to achieve a set of symbols that achieve a payout from the payout table, but to rank the player's symbols against the dealer's symbols based upon the payout table, the winner being having the highest rank and, in some embodiments, the bonus provided for certain combinations for symbols.

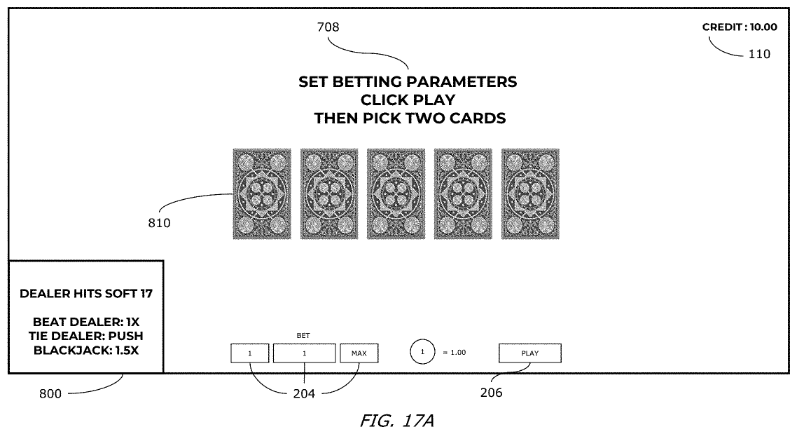

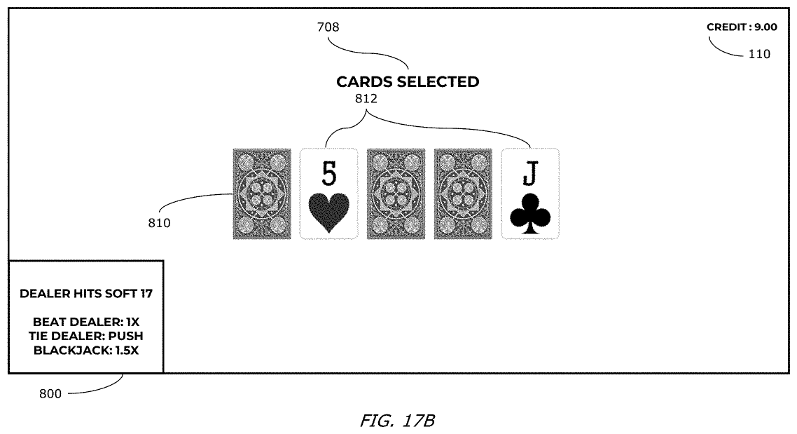

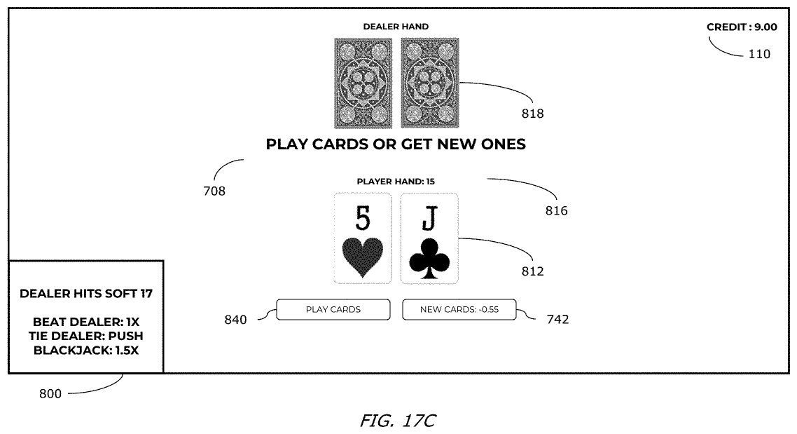

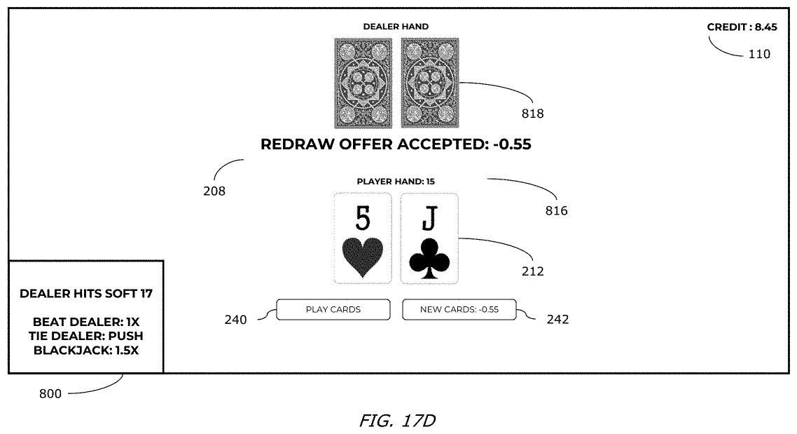

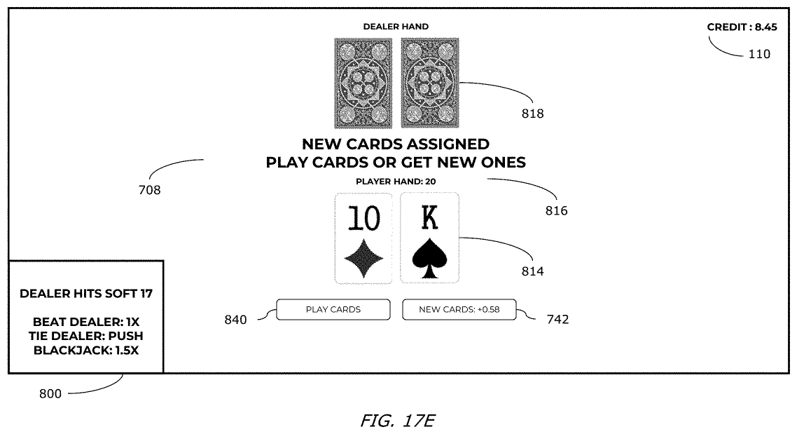

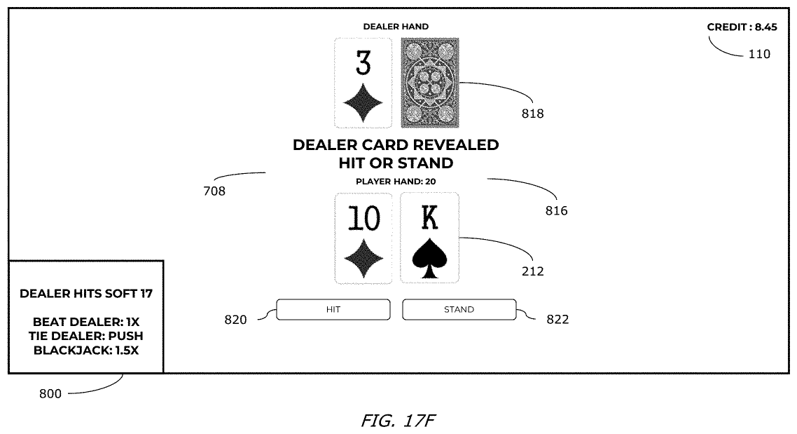

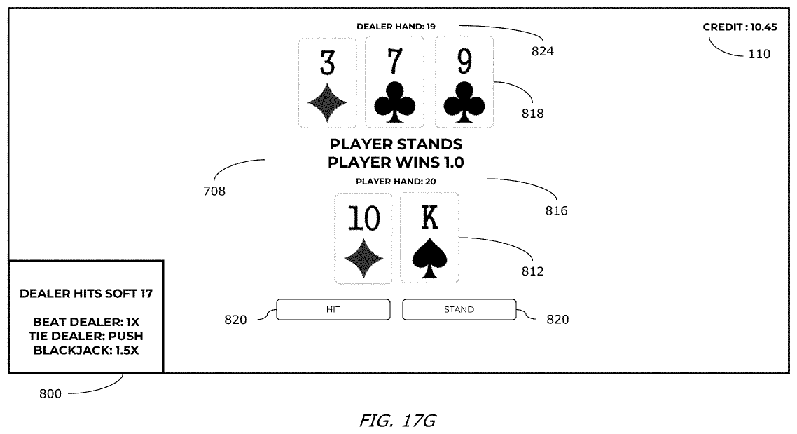

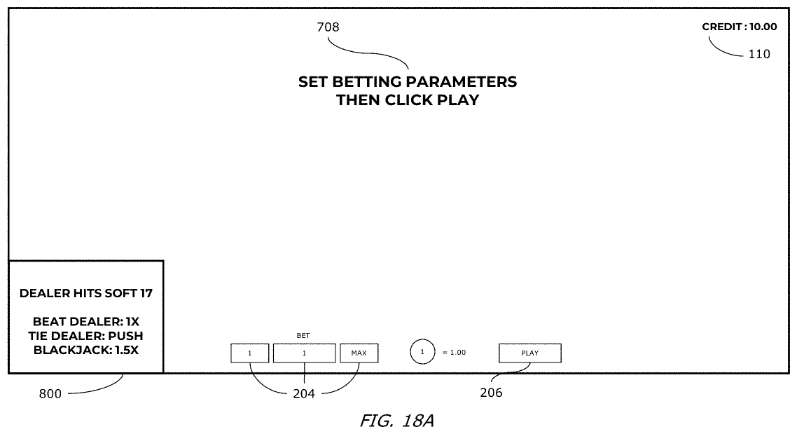

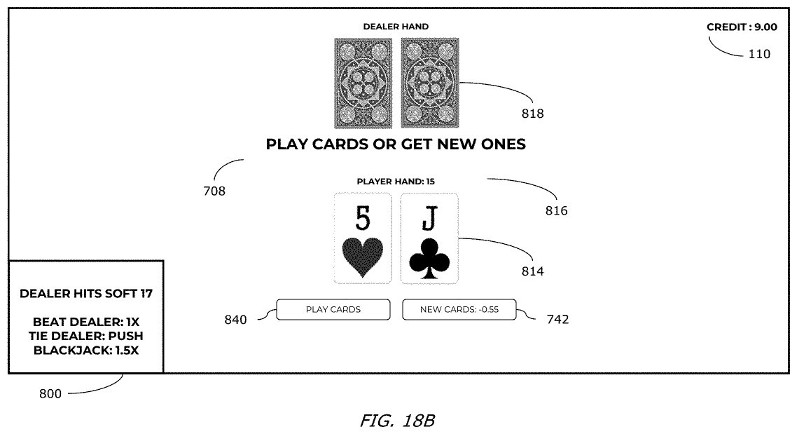

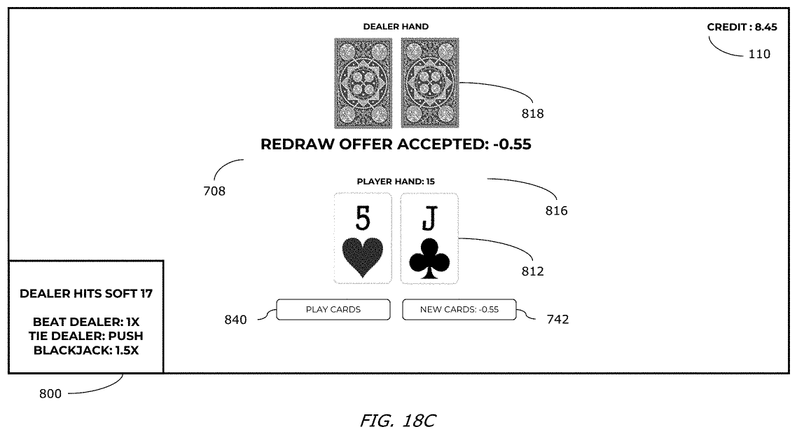

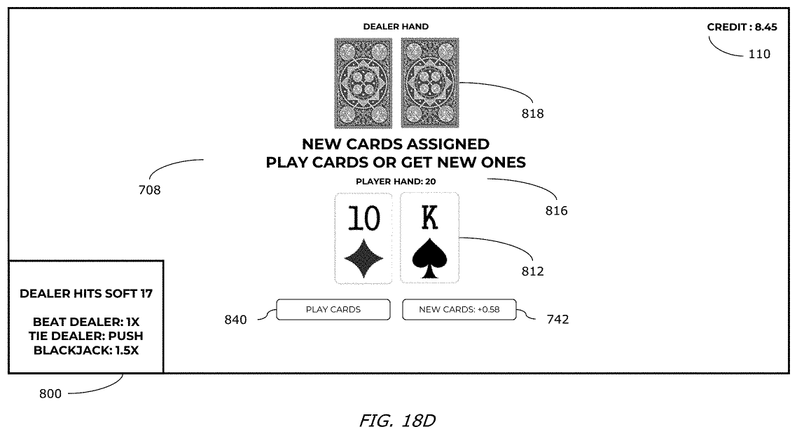

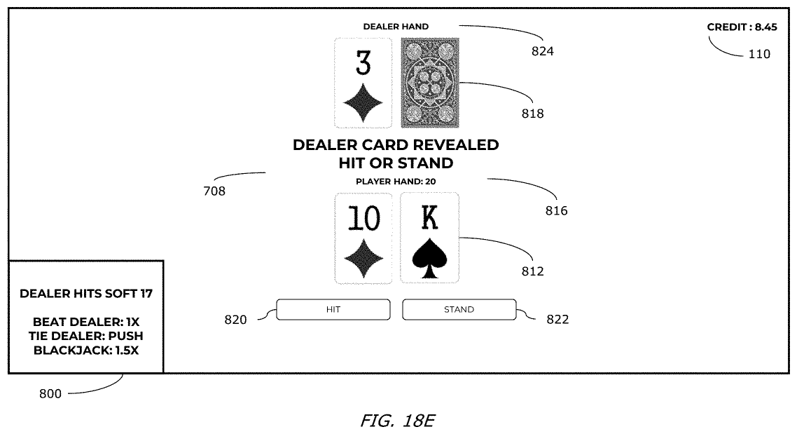

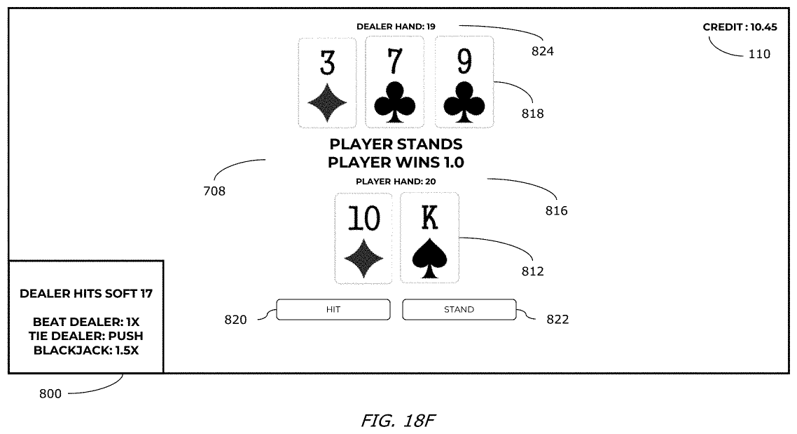

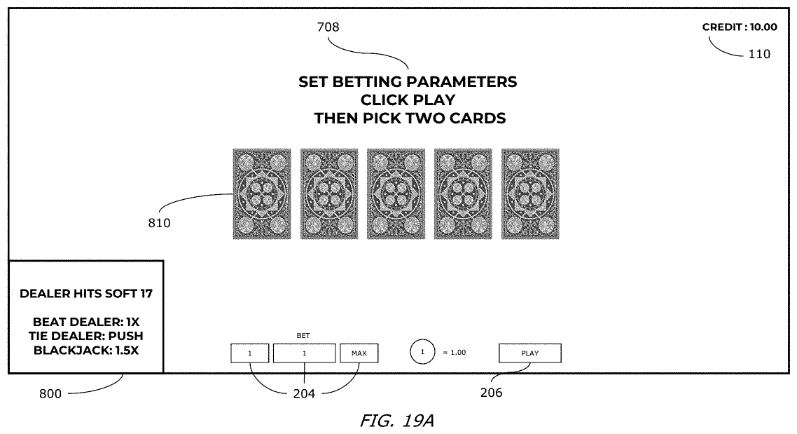

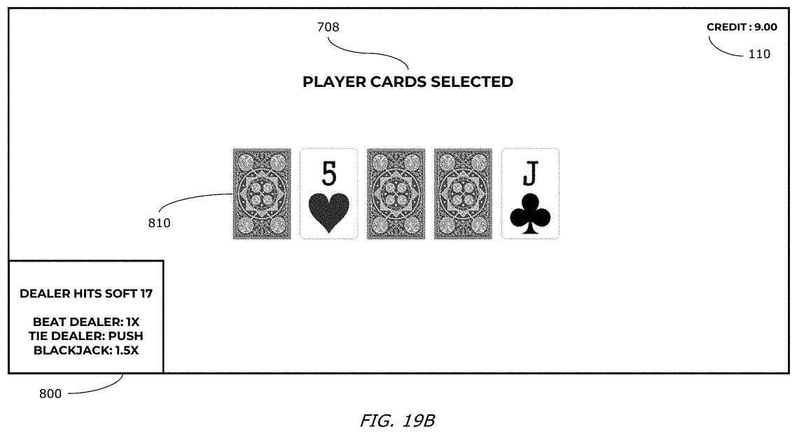

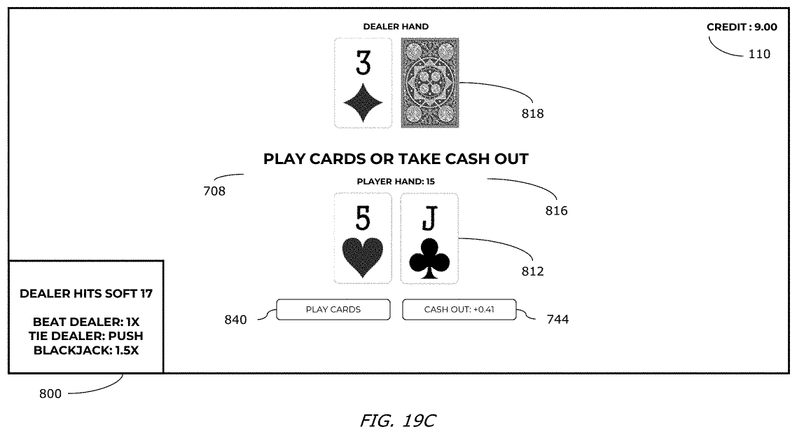

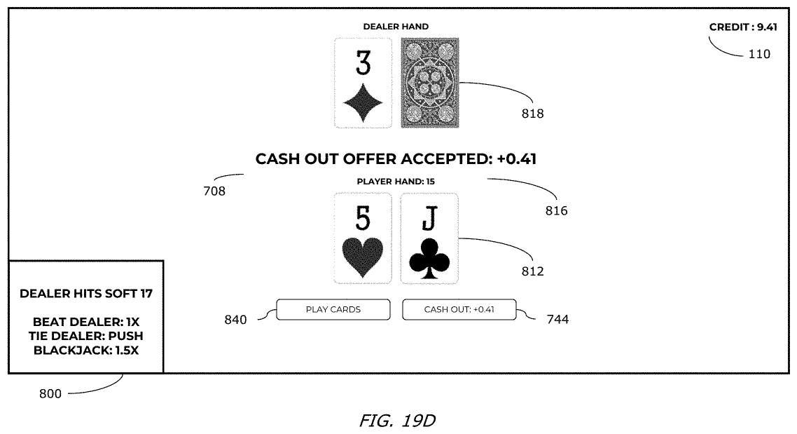

Referring to FIGS. 17A-G, 18A-F, 19A-D, and 20A-C, forms of a blackjack game are shown with one-step progressions (FIGS. 18A-F and 20A-C), two step progressions (FIGS. 17A-G and 19A-D) with redraw (FIGS. 17A-G and 18A-F) and/or with surrender (FIGS. 19A-D and 20A-C).

In FIG. 17A, an initial user interface for the two-step blackjack game with redraw is shown including a title 708, a rule box 800, and a credit box 110 showing funds/points available to the player. The player adjusts their bet using a wager selector 204. Once the player is ready, the player starts the blackjack game using the deal button 206 (e.g., play button). In FIG. 17A, the card symbol boxes 810 are blank until the player selects two of the card symbol boxes 810 as their hand. Note that at some time from the beginning of the game until any or all of the card symbol boxes 810 are revealed, a random card symbol (e.g., 7-spades, K-diamonds) are assigned to each of the slot symbol boxes.

After selecting the deal button 206, the user interface of FIG. 17B is displayed. Note that the player's bet has been deducted from the credit box 110. The player has selected the second and fifth card symbol box 810 which are now the player's hand 812 are shown (5-hearts and J-clubs).

Now, a present value of the player's hand 812 is calculated based upon the probability of the player's hand 812 beating the dealer's hand 818 as per the rule box 800. For example, the player has 15 which requires the dealer bust, so all card sequences are analyzed to determine the probability of the player winning given the player's hand 812 of 15. This payoff value is calculated as −0.55 and is a redraw offer 842 for the player to redraw or get new cards as shown in FIG. 17C. In this example, the player would pay 0.55 to get new cards that may be better or worse. If the redraw offer 842 is accepted, 0.55 is subtracted from the player's credit as shown in FIG. 17D and the credit box 110 in the user interface of FIG. 17D now shows the total of 9−0.55, or 8.45. The current game continues and the player is assigned a new hand 814 (e.g., a 10-diamonds and K-spades) as shown in FIG. 17E.

The player is still in the same game, and a new redraw offer 842 of +0.58 is available in FIG. 17E. In this example, the player has 20 and selects play cards 840 resulting in FIG. 17F. In FIG. 17F, one card of the dealer's hand 818 is revealed (3-diamonds), and typical blackjack-style hit 820 and stand 822 selections are made. In this example, in FIG. 17G, the player, having 20, selects the stand 822 option and the dealer's hand is revealed (3-diamonds and 7-clubs) and automatically takes a hit as the dealer does not have 17 or better, resulting in a 9-clubs with a hand total of 19 as shown as the dealer hand value 824. The player wins and is credited with a total return of +2.0, representing the 1.0 credit win and the return of the player's bet as reflected in the credit box 110.

In FIG. 18A, an initial user interface for the one-step blackjack game with redraw is shown including a title 708, a rule box 800, a credit box 110 showing funds/points available to the player. The player adjusts their bet using a wager selector 204. Once the player is ready, the player starts the blackjack game using the deal button 206 (e.g., play button). After the player selects the deal button 206, the user interface of FIG. 18B is displayed. Note that the player's bet has been deducted from the credit box 110. In the one-step blackjack game, the player's hand 814 is automatically revealed (5-hearts and J-clubs).

Now, a present value of the player's hand 814 is calculated based upon the probability of player's hand 814 winning against all combinations of the dealer's hand 818 which is not revealed yet, in this example, −0.55, and if the redraw offer 842 (new cards) is accepted, 0.55 is subtracted from the player's credit as shown in FIG. 18C and the credit box 110 in the user interface of FIG. 18C now shows the total of 9−0.55, or 8.45.

The game now continues as shown in FIG. 18D with new cards assigned to the player's hand 812 as this is a one-step game, showing a 10-diamonds and k-spades. Again, the present value of the player's hand 812 is calculated as above and, this time, the redraw offer 842 is +58 as shown in FIG. 18D, due to the higher value of the player's hand 812 (a 20). In this example, the player selects play cards 840 which results in revealing the first card of the dealer's had 818 as shown in FIG. 18E (3-diamonds). The player can now hit 820 or stand 822 and the player selects stand 822. In FIG. 18F, the dealer's hand 818 is revealed (3-diamonds and 7-clubs) and the dealer takes a hit, getting the 9-clubs, resulting in a dealer hand value 824 of 19. An evaluation is made as to whether the player wins, based upon the rule box 800, and the player wins 1.0 based upon the player's hand value 816 of 20 being higher than the dealer hand value 824 of 19 and the credit box 110 now shows a total of 8.45+2 (total return is 2, 1 for the win and 1 for the return of the bet), or 10.45.

In FIG. 19A, an initial user interface for the two-step blackjack game with surrender is shown including a title 708, a rule box 800, a credit box 110 showing funds/points available to the player. The player adjusts their bet using a wager selector 204. Once the player is ready, the player starts the slot game using the deal button 206 (e.g., play button). In FIG. 19A, the player's hand boxes 810 are blank until the player selects two of the player's hand boxes 810 (e.g., the two-step process). Note that at some time from the beginning of the game until any or all of the player's hand boxes 810 are revealed, a random card assigned to each of the player's hand boxes 810.

After selecting the deal button 206, the user interface of FIG. 19B is displayed and the player has selected two of the player's hand boxes 810 (5-hearts and J-clubs). Note that the player's bet has been deducted from the credit box 110. Now, in FIG. 19C, one card of the dealer's hand 818 is revealed (3-diamonds) and a present value of the player's hand 812 is calculated based upon the probability of player's hand 812 beating all possible dealer's hands that include the card already revealed in the dealer's hand 818, a second card and any hits taken by the dealer. The player is then presented with a surrender offer 744, in this example, +0.41, and if the surrender offer 744 is accepted, 0.41 is added to the player's credit as shown in FIG. 19D and the credit box 110 in the user interface of FIG. 19D now shows the total of 9+0.41, or 9.41. The current game is now finished and the player is offered to play a new game.

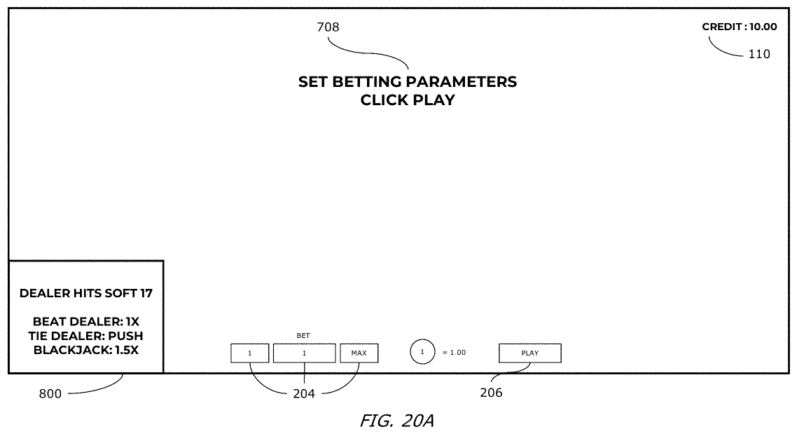

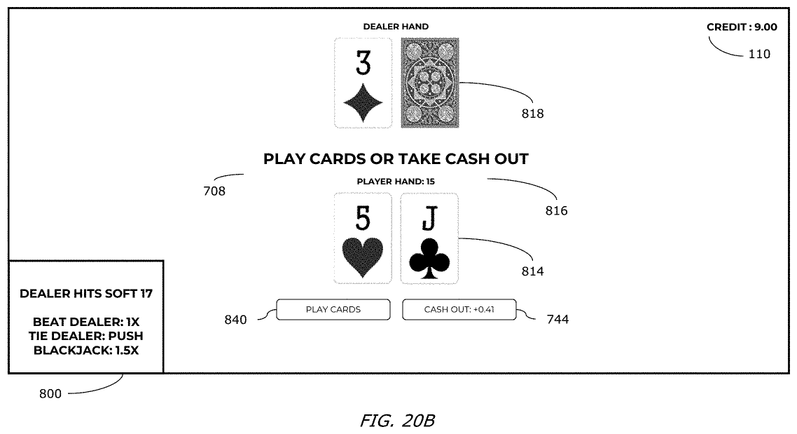

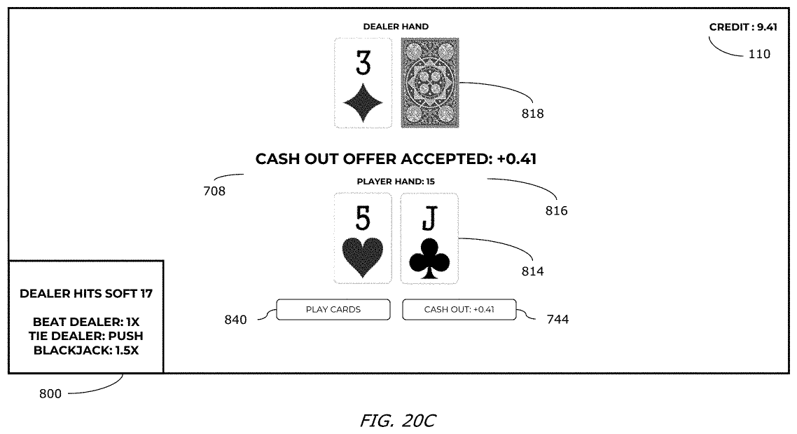

In FIG. 20A, an initial user interface for the one-step blackjack game with surrender is shown including a title 708, a rule box 800, a credit box 110 showing funds/points available to the player. The player adjusts their bet using a wager selector 204. Once the player is ready, the player starts the slot game using the deal button 206 (e.g., play button).

After selecting the deal button 206, the user interface of FIG. 20B is displayed. Note that the player's bet has been deducted from the credit box 110. The player is presented with their hand 814 (two cards randomly selected from a deck of cards) and one card of the dealer's hand 818 is revealed.

Now, a present value of the player's hand 812 is calculated based upon the probability of player's hand 812 beating all possible dealer's hands 818 based upon the card of the dealer's hand 818 that is revealed. The player is then presented with a surrender offer 744 (cash out), in this example, +0.41, and if the surrender offer 744 is accepted, 0.41 is added to the player's credit as shown in FIG. 20C and the credit box 110 in the user interface of FIG. 16C now shows the total of 9+0.41, or 9.41. The game is now over and the player can quit or play another game.

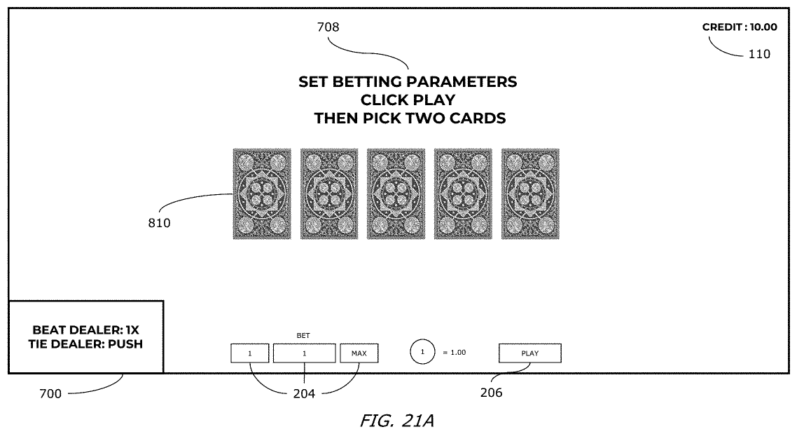

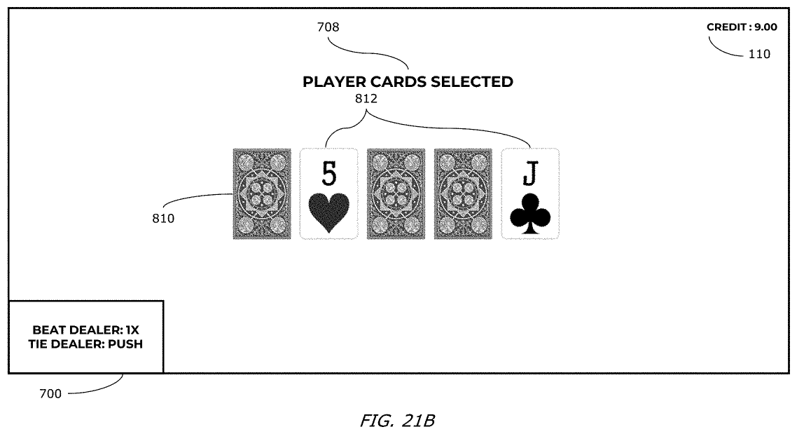

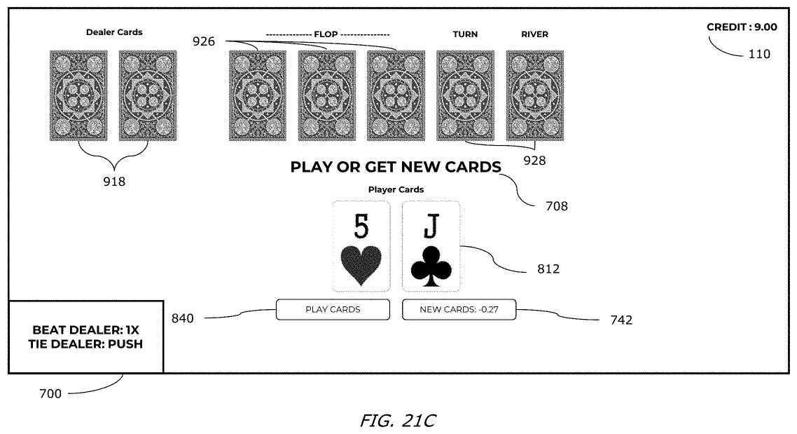

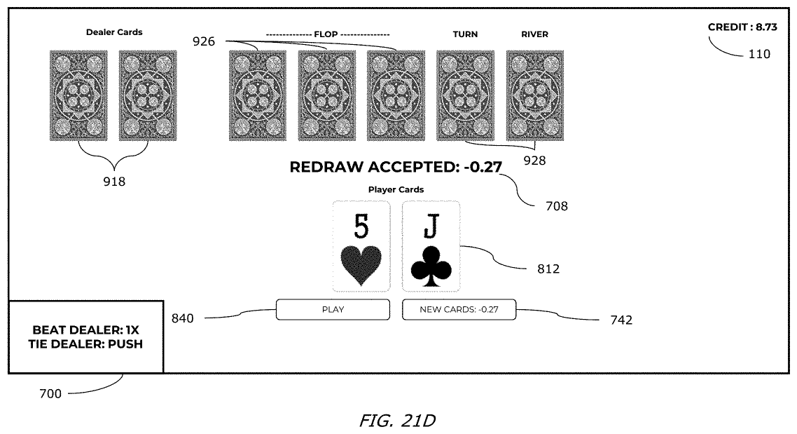

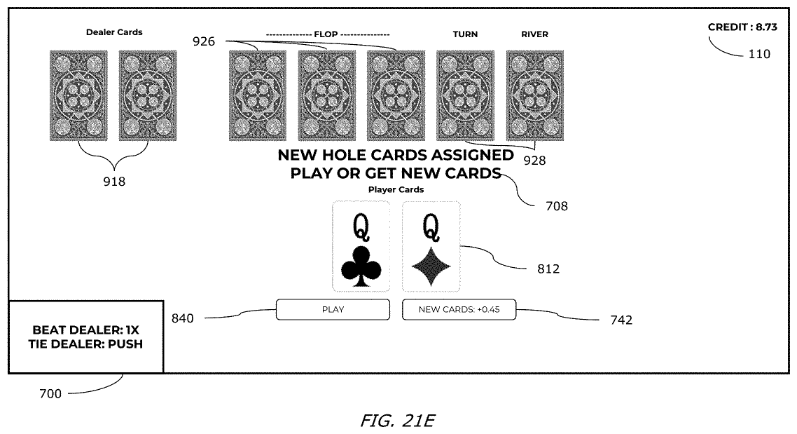

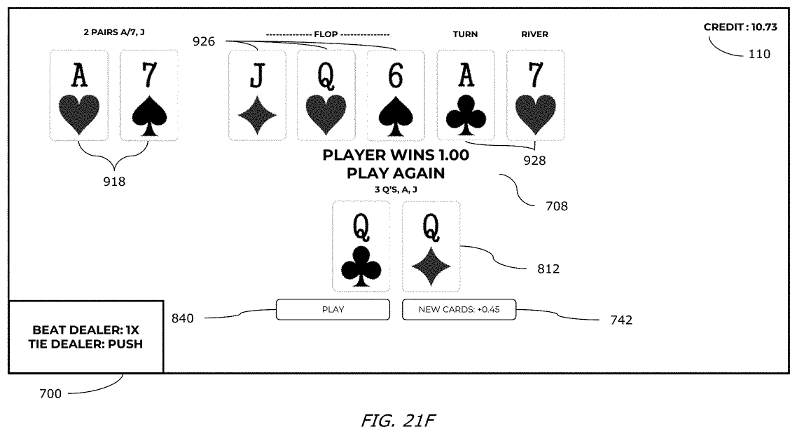

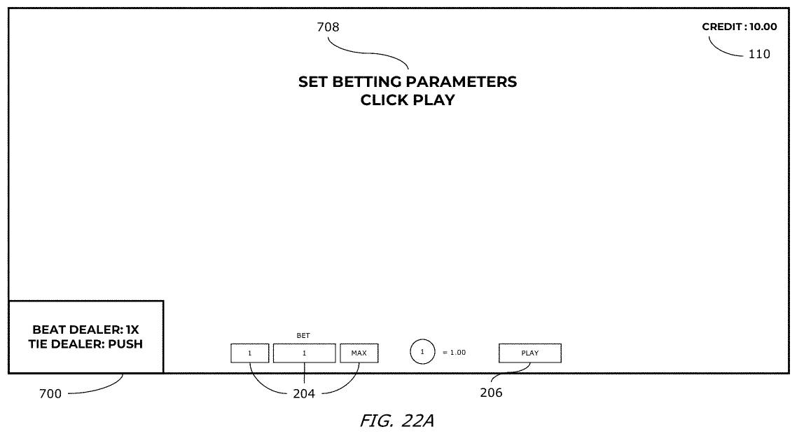

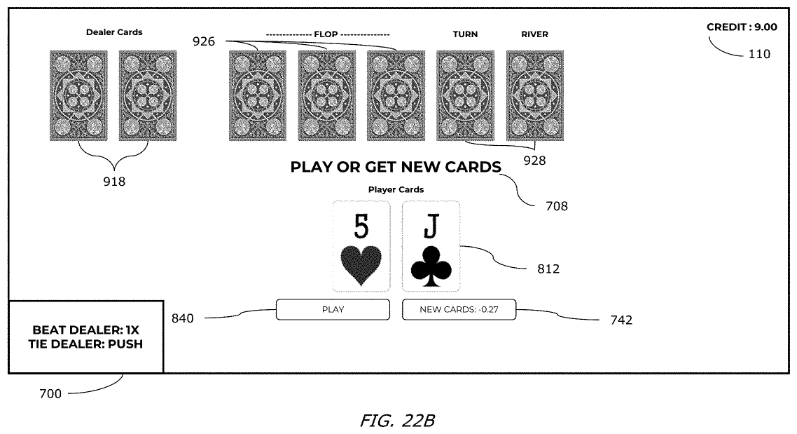

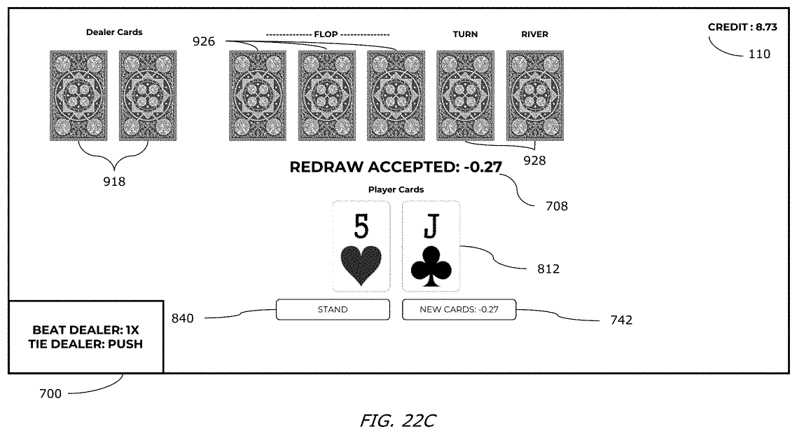

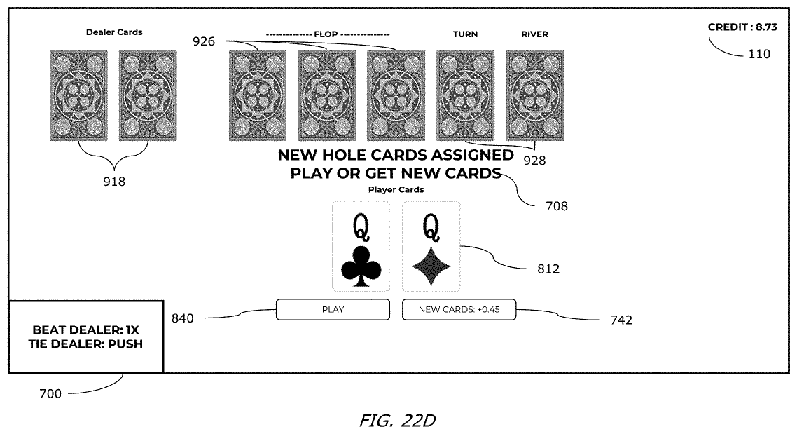

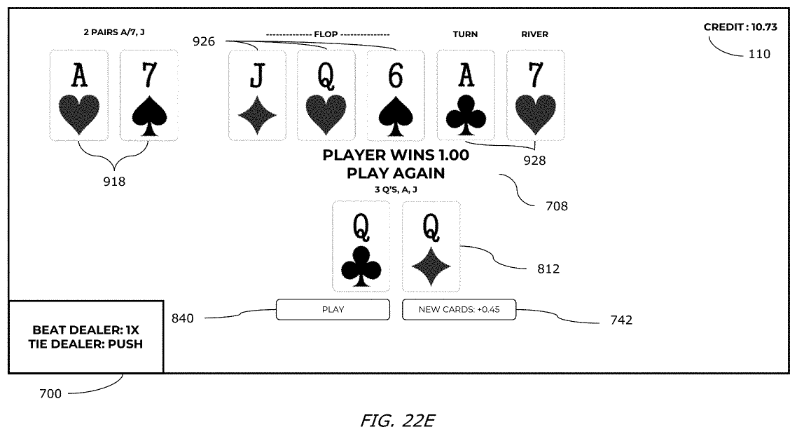

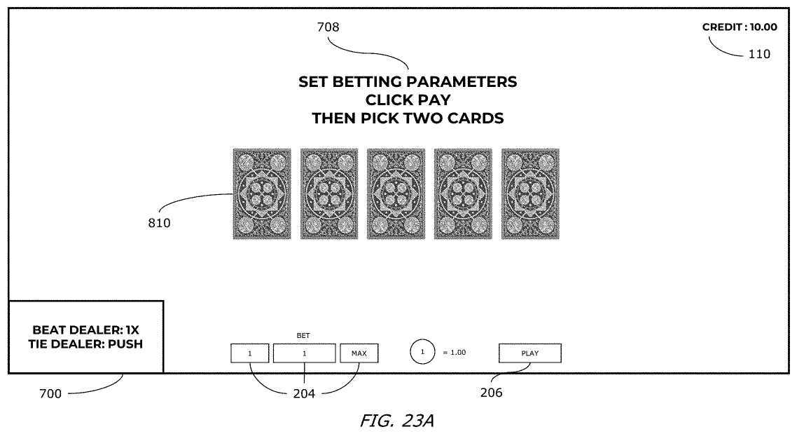

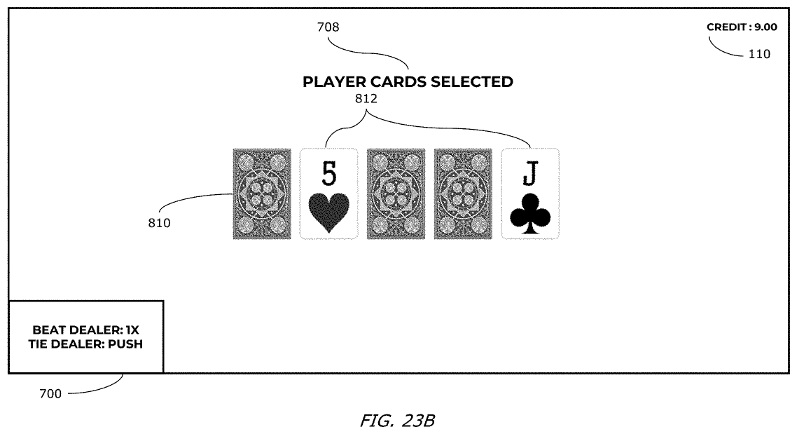

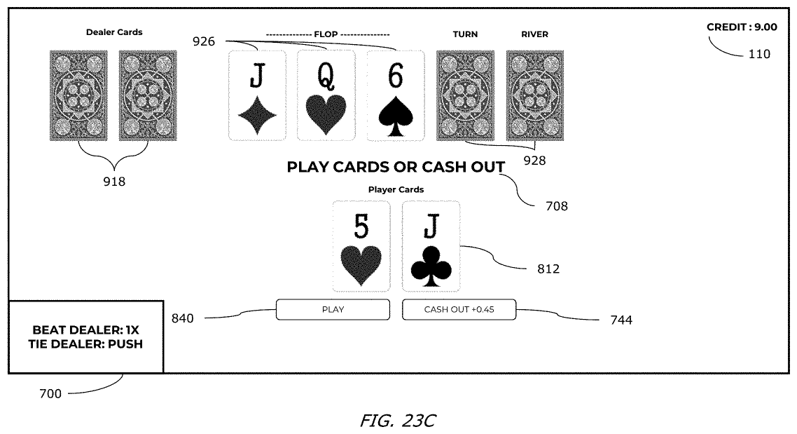

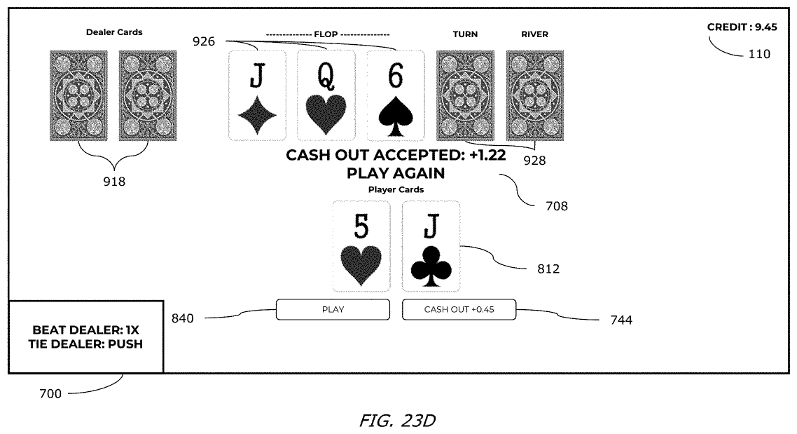

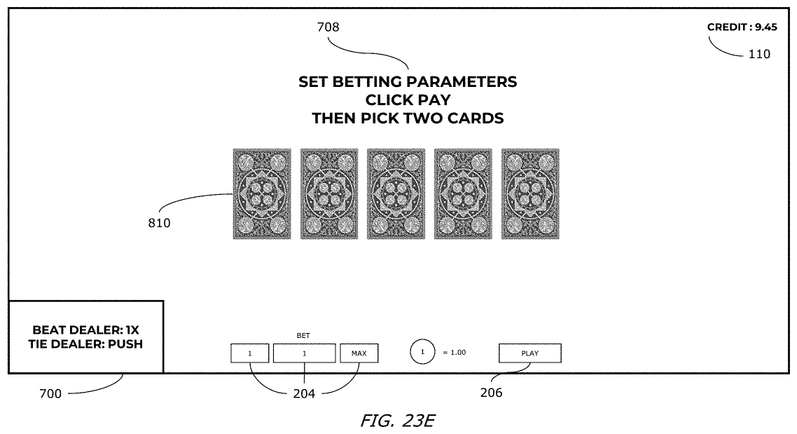

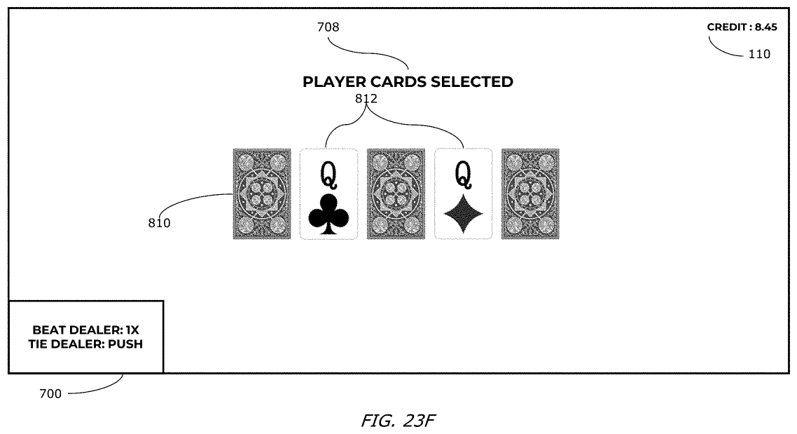

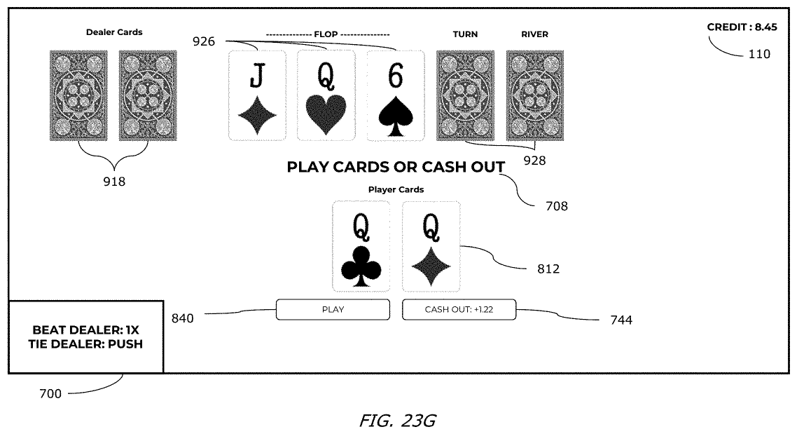

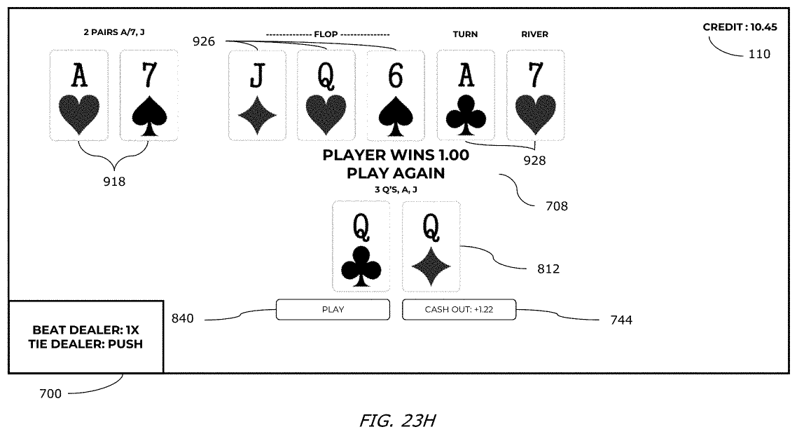

Referring to FIGS. 21A-F, 22A-E, 23A-E, and 24A-C, forms of a Texas-holdem game are shown with one-step progressions (FIGS. 22A-E and 24A-C), two step progressions (FIGS. 21A-F and 23A-E) with redraw (FIGS. 21A-F and 22A-E) and/or with surrender (FIGS. 23A-E and 24A-C).

In FIG. 21A, the user interface presents card symbol boxes 810 (five are shown of the two step progression Texas holdem game with redraw, though any number of card symbol boxes 810 are anticipated) along with a wager selector 204 and a deal button 206. After betting, the player selects two of the card symbol boxes 810 as shown in FIG. 21B, making up the player's hand 812. A present value of the player's hand 812 is calculated (probability of having a better hand then the dealer holdem hand 918 based upon random flop 926, and turn/river 928 cards. In FIG. 21C, the player is presented with a redraw offer 742 of −0.27, an amount to be paid by the player to obtain a new player's hand 812. Alternately, the player can select play 840 and play against the dealer's holdem hand 918 using the current player's hand 918. In FIG. 21D, the player accepts the redraw offer 742 and 0.27 is deducted from the credit box 110, leaving 8.73 and FIG. 21E is displayed showing the new player's hand 812. In this case, the redraw offer 742 is +0.45 being that the new player's hand 812 (Q-clubs, Q-diamonds) is a probable winner. In FIG. 21F, the player has selected play 840 and the dealer's holdem hand 918, the flop 926, and the turn/river 928 cards are revealed. The player has three queens, which beats the dealer holdem hand 918 of two pair, awarding the player a total return of 2 credits, 1 credit for winning and 1 for the original bet, which is returned, and the credit box 110 now shows a total of 8.73+2, or 10.73.

In FIG. 22A, the user interface presents a wager selector 204 and a deal button 206. After betting, two cards are randomly selected to make up the player's hand 812 as shown in FIG. 22B. A present value of the player's hand 812 is calculated (probability of having a better hand than the dealer holdem hand 918 based upon random flop 926, and turn/river 928 cards. In FIG. 22B, the player is presented with a redraw offer 742 of −0.27, an amount to be paid by the player to obtain a new player's hand 812. Alternately, the player can select play 840 and play against the dealer's holdem hand 918 using the current player's hand 918. In FIG. 22C, the player accepts the redraw offer 742 and 0.27 is deducted from the credit box 110, leaving 8.73 and FIG. 22D is displayed showing the new player's hand 812. In this case, the redraw offer 742 is +0.45 being that the new player's hand 812 (Q-clubs, Q-diamonds) is a probable winner. In FIG. 22E, the player has selected play 840 and the dealer's holdem hand 918, the flop 926, and the turn/river 928 cards are revealed and the player has three queens, which beats the dealer holdem hand 918 of two pair, awarding the player a total return of 2 credits, 1 credit for winning and 1 for the original bet, which is returned, and the credit box 110 now shows a total of 8.73+2, or 10.73.

In FIG. 23A, the user interface presents card symbol boxes 810 (five are shown of the two step progression Texas holdem game with surrender, though any number of card symbol boxes 810 are anticipated) along with a wager selector 204 and a deal button 206. After betting, the player selects two of the card symbol boxes 810 as shown in FIG. 23B, making up the player's hand 812. In FIG. 23C, the flop 926 is revealed. A present value of the player's hand 812 is calculated (probability of having a better hand then the dealer holdem hand 918 based upon the flop 926, and random turn/river 928 cards and the player is presented with a surrender offer 744 of 0.45, an amount to be paid by the player to abandon the player's hand 812. Alternately, the player can select play 840 and play against the dealer's holdem hand 918 using the current player's hand 918. In FIG. 23D, the player accepts the surrender offer 744 and 0.45 is added to the credit box 110, now 9.45.

In FIG. 23E, the user interface presents card symbol boxes 810 (five are shown, though any number are anticipated) along with a wager selector 204 and a deal button 206. After betting, the amount of the wager is debited from the credit box 110 and two cards are randomly selected to make up the player's hand 812 as shown in FIG. 23F. In this example in FIG. 23G, the flop 926 is revealed. A present value of the player's hand 812 is calculated (probability of having a better hand then the dealer holdem hand 918 based upon the flop 926, and random turn/river 928 cards and the player is presented with a surrender offer 744 of 1.22, an amount to be paid by the player to abandon the player's hand 812. Alternately, the player can select play 840 and play against the dealer's holdem hand 918 using the current player's hand 812. In FIG. 23H, the player has selected play 840 and the dealer's holdem hand 918 and the turn/river 928 cards are revealed. In FIG. 23H, the player has three queens, which beats the dealer holdem hand 918 of two pair and the credit box 110 now shows a total of 8.45+2, or 10.45, which represents the prior player credit balance plus a total return of the players winnings of 1 credit and the return of their initial wager of 1 credit.

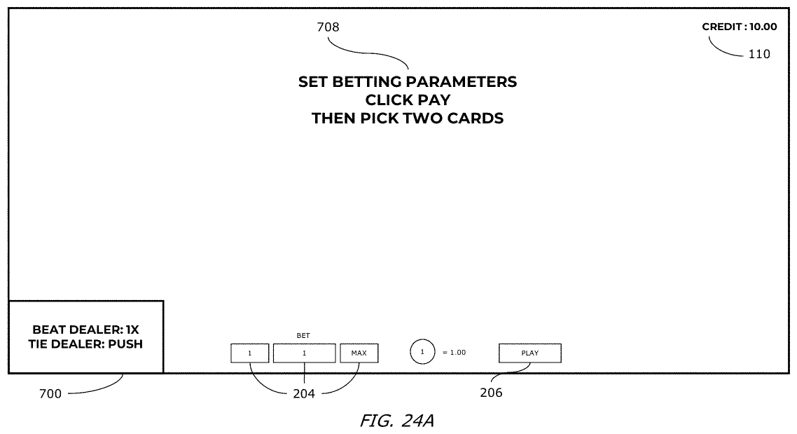

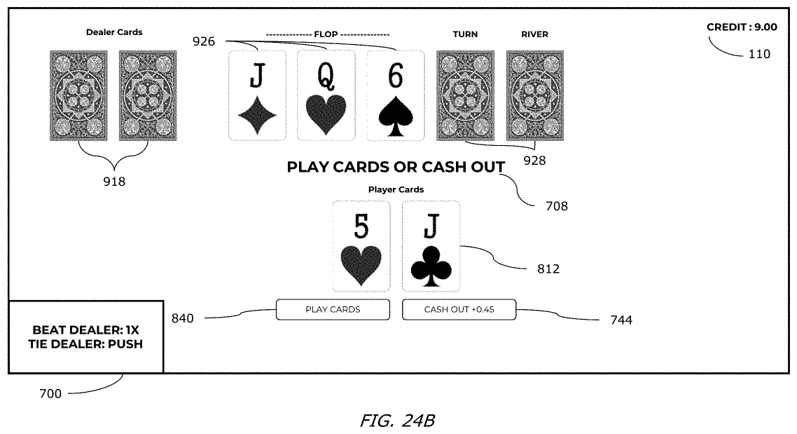

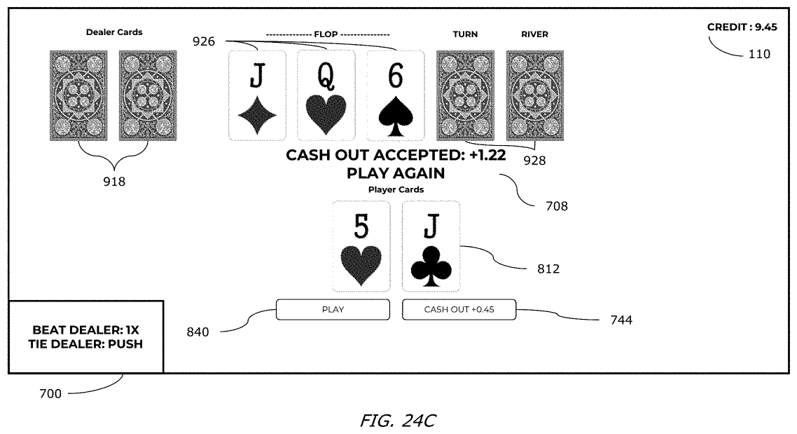

In FIG. 24A, the user interface presents a wager selector 204 and a deal button 206. After the deal button 206 is clicked (e.g., play is selected), the amount of the wager is debited from the credit box 110 and two cards are randomly selected as the player's hand 812 and displayed as shown in FIG. 24B and flop 926 is also revealed, though in other embodiments, the flop 926 is not exposed until play 840 is selected. A present value of the player's hand 812 is calculated (probability of having a better hand then the dealer holdem hand 918 based upon the flop 926, and random turn/river 928 cards. The player is presented with a surrender offer 744 of +0.45, an amount to be paid by the player to abandon the player's hand 812. Alternately, the player can select play 840 and play against the dealer's holdem hand 918 using the current player's hand 812. In FIG. 24C, the player has selected surrender offer 744 and the player is credited with the surrender offer 744 of 0.45, making the credit box 110 show 9.45.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. An improved gaming system comprising:
a game server, the game server having an account for recording winnings and losses;
a software representation of a set of symbols;
a payout table accessible by the game server, the payout table includes a payout amount for achieving each of certain combinations of symbols from the set of symbols;
the game server displays a user interface that requests a wager;
after the wager is entered in the user interface, the game server subtracts the wager from the account;
the game server randomly selects a first number of symbols from the set of symbols into a first subset of symbols;
the game server displays the first subset of symbols;
the game server analyzes the first subset of symbols in real time to determine a combination of the first subset of symbols that yield a highest payout amount from the payout table;
the game server calculates a present value of the first subset of symbols, in real time, by: setting the present value to the highest payout amount and then for each possible combinations of a second subset of symbols taken from symbols in the set of symbols, adding to the present value a product of a probability of achieving the second subset of symbols and a payout amount for achieving the first subset of symbols combined with the second subset of symbols from the payout table;
the game server sets a redraw offer to the present value minus a discount percentage times the wager;
the game server displays the redraw offer along with an accept directive and a reject directive;
upon activation of the accept directive, the game server credits the account with the redraw offer, the game server randomly selects the first number of symbols from the set of symbols into the first subset of symbols, the game server displays the first subset of symbols, the game server randomly selects the second subset of symbols from the set of symbols, the game server analyzes the first subset of symbols combined with the second subset of symbols to determine the combination of the first subset of symbols with the second subset of symbols that yields the highest payout amount from the payout table, then the game server credits the account with the highest payout amount; and the game server displays the second subset of symbols, the combination of the first subset of symbols with the second subset of symbols that yield the highest payout amount and the highest payout amount; and
upon activation of the reject directive, the game server randomly selects the second subset of symbols from the symbols remaining in the set of symbols and the game server analyzes the first subset of symbols combined with the second subset of symbols to determine the combination of the first subset of symbols with the second subset of symbols that yields the highest payout amount from the payout table, then the game server credits the account with the highest payout amount; and the game server displays the second subset of symbols, the combination of the first subset of symbols with the second subset of symbols that yield the highest payout amount and the highest payout amount.

2. The improved gaming system of claim 1, wherein the set of symbols comprises slot machine symbols.

3. The improved gaming system of claim 1, wherein the set of symbols is weighted to set a probability of each randomly selecting each symbol to correspond to the payout table.

4. The improved gaming system of claim 2, wherein the slot machine symbols are selected from a group of symbols comprising a triple-bar symbol, a “7” symbol, a bell symbol, a watermelon symbol, a bananas symbol, a cherries symbol, and a lemon symbol.

5. The improved gaming system of claim 1, wherein the discount percentage is zero.

6. An improved gaming system comprising:
a game server, the game server having an account for recording winnings and losses;
a software representation of a set of cards;
a payout table accessible by the game server, the payout table includes a payout amount for a player hand beating a dealer hand based upon game rules;
the game server displays a user interface that requests a wager;
after the wager is entered in the user interface, the game server subtracts the wager from the account;
the game server randomly selects and moves a first number of cards from the set of cards into the player hand, moves the first number of cards from the set of cards into the dealer hand and moves a second number of cards from the set of cards into a set of community cards;
the game server displays a sub-set of the player hand, a sub-set of the dealer hand and a sub-set of the set of community cards;
based on the sub-set of the player hand, the sub-set of the dealer hand and the sub-set of the set of community cards, the game server calculates the present value of the player hand in real time as the product of (1) the probability of the player hand beating the dealer hand multiplied by the total return to the player for beating the dealer hand, which is based on the amount wagered and the payout table, plus (2) the probability of the player hand tying the dealer hand multiplied by the total return to the player for the player hand tying the dealer hand, which is based on the amount wagered and the payout table;
the game server then sets a redraw offer to the present value minus a discount percentage times the wager minus the wager;
the game server displays the redraw offer along with an accept directive and a reject directive;
upon activation of the accept directive, the game server adds the redraw offer to the account, the game server again randomly selects and moves the first number of cards from the set of cards into the player hand, then the game server displays the player hand, the dealer hand and the set of community cards, then game server resumes game play, which continues until either the player hand or the dealer hand wins which ends the game, then when the player hand beats the dealer hand, the game server credits the account by the amount for the player hand beating the dealer hand plus the wager; and
upon activation of the reject directive, the game server displays the player hand, the dealer hand and the set of community cards, then game server resumes game play, which continues until either the player hand or the dealer hand wins, which ends the game, then when the player hand beats the dealer hand, the game server adds the amount for beating the dealer plus the wager to the account.

7. The improved gaming system of claim 6, wherein the game rules are for stud poker.

8. The improved gaming system of claim 6, wherein the game rules are for Texas Hold'em.

9. The improved gaming system of claim 6, wherein the first number of cards is two and the sub-set of the player hand is two cards and the sub-set of the dealer hand is empty.

10. The improved gaming system of claim 6, wherein the first number of cards is two and the sub-set of the player hand is two cards and the sub-set of the dealer hand one card.

11. The improved gaming system of claim 6, wherein the second number of cards is zero.

12. The improved gaming system of claim 6, wherein the discount percentage is zero.

13. The improved gaming system of claim 5, wherein the second number of cards is five and the sub-set of the set of community cards is selected from a group consisting of one card, two cards, and three cards.

14. An improved gaming system comprising:
a game server, the game server having an account for recording winnings and losses;
a software representation of a set of cards;
a payout table accessible by the game server, the payout table includes a payout amount for a player hand beating a dealer hand based upon game rules;
the game server displays a user interface that requests a wager;
after the wager is entered in the user interface, the game server subtracts the wager from the account;
the game server randomly selects and moves a first number of cards from the set of cards into the player hand and moves the first number of cards from the set of cards into the dealer hand;
the game server displays a sub-set of the player hand and a sub-set of the dealer hand;
based on the sub-set of the player hand and the sub-set of the dealer hand, the game server calculates the present value of the player hand in real time as the product of (1) the probability of the player hand earning a blackjack without also tying the dealer multiplied by total return to the player for the player hand achieving a blackjack without also tying the dealer, which is based on the amount of the wager and the payout table, plus (2) the probability of the player hand beating the dealer hand multiplied by the total return to the player for beating the dealer hand, which is based on the amount wagered and the payout table, plus (3) the probability of the player hand tying the dealer hand multiplied by the total return to the player for the player hand tying the dealer hand, which is based on the amount wagered and the payout table;
the game server then sets a redraw offer to the present value minus the wager minus a discount percentage times the wager;
the game server displays the redraw offer along with an accept directive and a reject directive;
when the accept directive is activated, the game server adds the redraw offer to the account, the game server randomly selects and moves the first number of cards from the set of cards into the player hand;
the game server displays the player hand and the dealer hand and resumes normal game play, which continues until either the player hand wins or the dealer hand wins and the game ends; and
when the player hand wins, the game server adds the amount of the payout for beating the dealer plus the amount of the wager to the account.

15. The improved gaming system of claim 14, wherein the discount percentage is zero.

16. The improved gaming system of claim 14, wherein the sub-set of the dealer hand is one card.

17. The improved gaming system of claim 14, wherein the first number of cards is two and the sub-set of the player hand is two cards.

18. The improved gaming system of claim 14, wherein the normal game play comprises displaying a user interface for requesting additional cards be added to the player hand from the set of cards until a sum of the player hand exceeds 21.

19. The improved gaming system of claim 18, wherein the normal game play further comprises until the sum of the dealer hand is greater than 16, moving an additional card to the dealer hand from the set of cards.

20. The improved gaming system of claim 19, wherein the normal game play further comprises if the sum of the player hand is greater than the sum of the dealer hand and the sum of the player hand is less than 22 or if the sum of the dealer hand is greater than 21, the player wins.
